(19) United States
(12) Patent Application Publication
(10) Pub. No.: US 2013/0034489 A1
(43) Pub. Date: Feb. 7, 2013

(54) ELECTROCHEMICAL HYDROXIDE SYSTEM AND METHOD USING FINE MESH CATHODE

(71) Applicants: RYAN J. GILLIAM, San Jose, CA (US); Bryan Boggs, Campbell, CA (US); Michael Kostowskyj, Los Gatos, CA (US); Nigel Antony Knott, Toronto (CA); Rebecca Lynne King, Santa Cruz, CA (US); Alexander Gorer, Los Gatos, CA (US)

(72) Inventors: RYAN J. GILLIAM, San Jose, CA (US); Bryan Boggs, Campbell, CA (US); Michael Kostowskyj, Los Gatos, CA (US); Nigel Antony Knott, Toronto (CA); Rebecca Lynne King, Santa Cruz, CA (US); Alexander Gorer, Los Gatos, CA (US)

(21) Appl. No.: 13/365,440

(22) Filed: Feb. 3, 2012

Related U.S. Application Data
(60) Provisional application No. 61/442,564, filed on Feb. 14, 2011.

(51) Int. Cl. C01B 31/24; C01F 5/24; C25B 9/00; C01F 11/18; C25B 1/20; C25B 13/00

(52) U.S. Cl. 423/430; 204/242; 204/265; 423/419.1

(57) ABSTRACT

Provided herein are methods and systems including contacting an anode electrolyte with an anode; contacting a cathode electrolyte with a cathode where cathode is a fine mesh cathode; and applying voltage across the anode and the cathode. The methods and systems further may include treating hydroxide ions produced at the cathode with carbon from a source of carbon.

### CROSS-REFERENCE TO RELATED APPLICATIONS

This application claims priority to U.S. Provisional Application No. 61/442,564, filed Feb. 14, 2011, which is incorporated herein by reference in its entirety.

### BACKGROUND

In many chemical processes, an alkaline solution is required to achieve a chemical reaction, e.g., to neutralize an acid, or buffer pH of a solution, or precipitate an insoluble hydroxide from a solution. One method by which the alkaline solution may be produced is by an electrochemical system. In producing an alkaline solution electrochemically, a large amount of energy, salt, and water may be used. Consequently, lowering the energy and the cost of the material used in the electrochemical process may be desired. One such challenge in the electrochemical system is the use of an efficient cathode.

### SUMMARY

In one aspect, there is provided a method, including contacting an anode with an anode electrolyte; contacting a cathode with a cathode electrolyte wherein the cathode comprises a fine mesh cathode; applying voltage across the anode and the cathode; producing hydroxide ions at the cathode; and treating the hydroxide ions with carbon from a source of carbon.

In some embodiments, the cathode further comprises a coarse mesh cathode. In some embodiments, the fine mesh cathode and/or coarse mesh cathode comprises metal, metal oxide, or combination thereof. In some embodiments, the fine mesh cathode is a woven mesh or an expanded mesh. In some embodiments, the fine mesh cathode comprises pores with a diamond shaped geometry or a square shaped geometry. In some embodiments, the fine mesh cathode is coated with a platinum group metal. In some embodiments, the fine mesh cathode has a pore size between 0.01 mm to 3 mm. In some embodiments, the fine mesh cathode is made of wire of thickness between 0.01 mm to 2.5 mm. In some embodiments, the fine mesh cathode has a percent open area of between 10% to 95%. In some embodiments, the fine mesh cathode reduces voltage applied across the anode and the cathode as compared to the voltage with a coarse mesh cathode. In some embodiments, the fine mesh cathode reduces the voltage by between 100 mV to 1000 mV. In some embodiments, the fine mesh cathode reduces resistance provided by the cathode electrolyte as compared to the resistance provided by the cathode electrolyte with a coarse mesh cathode.

In some embodiments, the fine mesh cathode provides an enhancement in current density across the anode and the cathode as compared to the current density with a coarse mesh cathode. In some embodiments, the fine mesh cathode provides an increase in active surface area thereby enhancing current density across the anode and the cathode. In some embodiments, the fine mesh cathode reduces deformation of an ion exchange membrane disposed between the anode and the cathode as compared to the deformation by a coarse mesh cathode. In some embodiments, the coarse mesh cathode has a pore size between 1 mm to 10 mm. In some embodiments, the coarse mesh cathode is made of wire of thickness between 0.5 mm to 5 mm.

In some embodiments, the cathode electrolyte comprises seawater, freshwater, brine, brackish water, sodium hydroxide, or combination thereof. In some embodiments, the anode electrolyte comprises seawater, freshwater, brine, brackish water, hydrochloric acid, or combination thereof. In some embodiments, the anode does not form a gas. In some embodiments, the method further comprises delivering hydrogen gas to the anode. In some embodiments, the hydrogen gas is produced at the cathode and the hydrogen gas is directed from the cathode to the anode. In some embodiments, the cathode electrolyte and the anode electrolyte are separated by an ion exchange membrane. In some embodiments, the ion exchange membrane is an anion exchange membrane, a cation exchange membrane, or both.

In some embodiments, the method further comprises producing hydroxide ions at the cathode without forming a gas at the anode on applying voltage across the anode and the cathode. In some embodiments, the method further comprises producing the hydroxide ions in the cathode electrolyte and hydrochloric acid in the anode electrolyte on applying the voltage across the anode and the cathode. In some embodiments, the hydroxide ions capture the carbon from the source of carbon to produce bicarbonate and/or carbonate ions.

In some embodiments, the method further comprises treating bicarbonate and/or carbonate ions with a divalent cation selected from the group consisting of calcium, magnesium, and combination thereof. In some embodiments, the method further comprises disposing a third electrolyte between the anode electrolyte and the cathode electrolyte. In some embodiments, the third electrolyte is separated from the anode electrolyte by an anion exchange membrane. In some embodiments, the anion exchange membrane is permeable to chloride ions. In some embodiments, the third electrolyte is separated from the cathode electrolyte by a cation exchange membrane. In some embodiments, the cation exchange membrane is permeable to sodium ions. In some embodiments, the third electrolyte comprises sodium chloride. In some embodiments, the carbon from the source of carbon is CO₂, carbonic acid, bicarbonate ions, carbonate ions, or combination thereof. In some embodiments, the source of carbon is gaseous stream of CO₂, a solution comprising dissolved CO₂, bicarbonate brine solution, or combination thereof.

In another aspect, there is provided an electrochemical cell system, including an anode in contact with an anode electrolyte; a cathode in contact with a cathode electrolyte wherein the cathode is a fine mesh cathode; and a contact system configured to contact the cathode electrolyte with carbon from a source of carbon. In some embodiments, the system further includes a device adapted to provide voltage across the anode and the cathode. In some embodiments, the system further includes a hydrogen gas delivery system to deliver hydrogen gas to the anode.

### BRIEF DESCRIPTION OF THE DRAWINGS

The following drawings illustrate by way of examples and not by limitation some embodiments of the present system and method.

FIG. 1 is an illustrative embodiment of the invention.

FIGS. 2A and 2B are an illustration of an embodiment of the invention.

FIGS. 3A and 3B are an illustration of an embodiment of the invention.

FIGS. 4A and 4B are an illustration of an embodiment of the invention.

FIGS. 5A and 5B are an illustration of an embodiment of the invention.

FIGS. 6A and 6B are an illustration of an embodiment of the invention.

FIG. 7 is an illustration of a gas diffusion anode.

FIG. 8 is an illustrative flow chart of an embodiment of the invention.

FIG. 9 is an illustrative flow chart of an embodiment of the invention.

FIG. 10 is an illustration of the experiment described in Example 1.

FIG. 11 is an illustration of the experiment described in Example 2.

### DETAILED DESCRIPTION

There are provided systems and methods that use a fine mesh cathode in an electrochemical cell. The use of the fine mesh cathode in the systems and methods provided herein, can lead to an increase in production capacity, an increase in energy efficiency, and/or reduction in an investment cost. The fine mesh cathode may result in one or more of following advantages: reduced solution resistance loss, i.e. reduced resistance for the cathode electrolyte; lower overvoltage; less or no damage or deformation of an ion exchange membrane in the cell upon contact with the cathode; reduced release of fouling ingredients, such as, metal ions; and increase in current density. The fine mesh cathode is found to have higher surface area as compared to flat plate electrodes or coarse mesh cathodes which may result in overall energy efficiency with a high hydrogen and hydroxide production rate.

There are also provided systems and methods for producing carbonate and/or bicarbonate compositions by using an alkaline solution obtained from the electrochemical cell containing the fine mesh cathode to capture carbon from a carbon source to form bicarbonate and/or carbonate materials. The electrochemical cell can be any electrochemical cell known in the art that produces an alkaline solution. Typically, an electrochemical cell comprises a cathode chamber comprising a cathode electrolyte and a cathode and an anode chamber comprising an anode electrolyte and an anode. As disclosed herein, on applying a voltage across the anode and the cathode, cations, e.g., sodium ions migrate to the fine mesh cathode to produce an alkaline solution including, sodium hydroxide. Upon reaction of the sodium hydroxide with carbon from a source of carbon, such as, but not limited to, CO₂, carbonic acid, bicarbonate, carbonate, or combination thereof, inside the cathode chamber or outside the cathode chamber, sodium carbonate and/or sodium bicarbonate is formed. In some embodiments, the electrochemical cell containing the fine mesh cathode produces an alkaline solution in the cathode electrolyte and an acid, such as a hydrochloric acid, or a chlorine gas in the anode electrolyte. Further, as described herein, hydrogen gas and hydroxide ions are produced at the cathode, and in some embodiments, some or all of the hydrogen gas produced at the cathode may be directed to the anode where it may be oxidized to produce hydrogen ions. The anions in the anode electrolyte, e.g., chloride ions may react with the hydrogen ions migrated from the anode to produce an acid, e.g., hydrochloric acid in the anode electrolyte. In some embodiments, a salt solution, e.g., sodium chloride or sodium sulfate, may be used as the anode electrolyte or the cathode electrolyte to produce the alkaline solution. In some embodiments, such salt solution is brine.

As can be appreciated by one ordinarily skilled in the art, since the present system and method can be configured with an alternative, equivalent salt solution, e.g., a potassium sulfate solution, or a sodium sulfate solution, or a magnesium sulfate solution, to produce an equivalent alkaline solution, e.g., potassium hydroxide and/or potassium carbonate and/or potassium bicarbonate or sodium hydroxide and/or sodium carbonate and/or sodium bicarbonate or magnesium hydroxide and/or magnesium carbonate in the cathode electrolyte, and an equivalent acid, e.g., sulfuric acid in the anode electrolyte, by applying the voltage as disclosed herein across the anode and cathode. The invention is not limited to the exemplary embodiments described herein, but is adaptable for use with an equivalent salt solution, e.g., potassium sulfate or magnesium sulfate, to produce an alkaline solution in the cathode electrolyte, e.g., potassium carbonate and/or potassium bicarbonate or magnesium carbonate, and an acid, e.g., sulfuric acid in the anode electrolyte. Accordingly, to the extent that such equivalents are based on or suggested by the present system and method, these equivalents are within the scope of the appended claims.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods and Systems

In one aspect, there is provided a method, including contacting an anode with an anode electrolyte; contacting a cathode with a cathode electrolyte where the cathode is a fine mesh cathode; and applying voltage across the anode and the cathode. In some embodiments, the cathode in the method further includes a coarse mesh cathode. In some embodiments, the method further includes producing hydroxide ions at the cathode and treating the hydroxide ions produced by the cathode with carbon from a source of carbon to form bicarbonate and/or carbonate materials. Accordingly, in one aspect, there is provided a method including contacting an anode with an anode electrolyte; contacting a cathode with a cathode electrolyte where the cathode is a fine mesh cathode; applying voltage across the anode and the cathode; producing hydroxide ions at the cathode; and treating the hydroxide ions with carbon from a source of carbon.

As used herein, “fine mesh cathode” includes a porous cathode with a pore size less than the pore size of the coarse mesh cathode. In some embodiments, the pore size of the fine mesh cathode is less than 10 mm; or less than 9 mm; less than 8 mm; or less than 7 mm; or less than 6 mm; or less than 5 mm; or less than 4 mm; or less than 3 mm; or less than 2 mm; or less than 1 mm; or between 0.001-10 mm; or between 0.001-9 mm; or between 0.001-8 mm; or between 0.001-7 mm; or between 0.001-6 mm; or between 0.001-5 mm; or between 0.001-4 mm; or between 0.001-3 mm; or between 0.001-2 mm; or between 0.001-1 mm; or between 0.01-10 mm; or between 0.01-9 mm; or between 0.01-8 mm; or between 0.01-7 mm; or between 0.01-6 mm; or between 0.01-5 mm; or between 0.01-4 mm; or between 0.01-3 mm; or between 0.01-2 mm; or between 0.01-1 mm; or between 0.1-10 mm; or between 0.1-9 mm; or between 0.1-8 mm; or between 0.1-7 mm; or between 0.1-6 mm; or between 0.1-5 mm; or between 0.1-4 mm; or between 0.1-3 mm; or between 0.1-2 mm; or between 0.1-1 mm; or between 0.4-10 mm; or between 0.4-9 mm; or between 0.4-8 mm; or between 0.4-7 mm; or between 0.4-6 mm; or between 0.4-5 mm; or between 0.4-4 mm; or between 0.4-3 mm; or between 0.4-2 mm; or between 0.4-1 mm; or between 0.5-10 mm; or between 0.5-9 mm; or between 0.5-8 mm; or between 0.5-7 mm; or between 0.5-6 mm; or between 0.5-5 mm; or between 0.5-4 mm; or between 0.5-3 mm; or between 0.5-2 mm; or between 0.5-1 mm; or between 1-10 mm; or between 1-9 mm; or between 1-8 mm; or between 1-7 mm; or between 1-6 mm; or between 1-5 mm; or between 1-4 mm; or between 1-3 mm; or between 1-2 mm; or between 2-10 mm; or between 2-9 mm; or between 2-8 mm; or between 2-7 mm; or between 2-6 mm; or between 2-5 mm; or between 2-4 mm; or between 2-3 mm; or between 3-10 mm; or between 3-9 mm; or between 3-8 mm; or between 3-7 mm; or between 3-6 mm; or between 3-5 mm; or between 3-4 mm; or between 0.5×10 mm; or between 0.5×9 mm; or between 0.5×8 mm; or between 0.5×7 mm; or between 0.5×6 mm; or between 0.5×5 mm; or between 0.5×4 mm; or between 0.5×3 mm; or between 0.5×2 mm; or between 0.5×1 mm; or between 1×10 mm; or between 1×9 mm; or between 1×8 mm; or between 1×7 mm; or between 1×6 mm; or between 1×5 mm; or between 1×4 mm; or between 1×3 mm; or between 1×2 mm; or between 1×1.5 mm; or 9 mm; or 8 mm; or 7 mm; or 6 mm; or 5 mm; or 4 mm; or 3 mm; or 2 mm; or 1 mm; or 0.5 mm; or 0.1 mm.

Applicants unexpectedly and surprisingly found that the fine mesh cathode of the invention has several advantages over the flat electrode and/or the coarse mesh cathode alone in the electrochemical systems including, but not limited to, higher surface area; increase in active sites; increase in hydrogen evolution rate; decrease in solution resistance; decrease in voltage applied across the anode and the cathode; decrease or elimination of resistance by the cathode electrolyte; increase in current density across the anode and the cathode; and/or decrease or elimination of deformation of an ion exchange membrane disposed between the anode and the cathode.

The fine mesh cathode may be characterized by various parameters including, but not limited to, mesh number which is a number of lines of mesh per inch; pore size; thickness of the wire or wire diameter; percentage open area, etc. These characteristics of the fine mesh cathode may affect the properties of the fine mesh cathode, such as, rate of evolution of hydrogen from the cathode; reduction of solution resistance; reduction of voltage applied across the anode and the cathode; enhancement of the current density across the anode and the cathode; and/or reduction of deformation of an ion exchange membrane disposed between the anode and the cathode.

As used herein, “coarse mesh cathode” includes a porous cathode with a pore size more than the pore size of the fine mesh cathode. The pore size of the coarse mesh cathode is more than 1 mm; or more than 3 mm; or more than 4 mm; or more than 5 mm; or more than 6 mm; or more than 7 mm; or more than 8 mm; or more than 9 mm; or more than 10 mm; or between 1-5 mm; or between 3-10 mm; or between 3-9 mm; or between 3-8 mm; or between 3-7 mm; or between 3-6 mm; or between 3-5 mm; or between 3-4 mm; or between 4-10 mm; or between 4-9 mm; or between 4-8 mm; or between 4-7 mm; or between 4-6 mm; or between 4-5 mm; or between 5-10 mm; or between 5-9 mm; or between 5-8 mm; or between 5-7 mm; or between 5-6 mm; or between 6-10 mm; or between 6-9 mm; or between 6-8 mm; or between 6-7 mm; or between 7-10 mm; or between 7-9 mm; or between 7-8 mm; or between 8-10 mm; or between 8-9 mm; or between 9-10 mm; or 3×10 mm; or 3×9 mm; or 3×8 mm; or 3×7 mm; or 3×6 mm; or 3×5 mm; or 3×4 mm; or 4×10 mm; or 4×9 mm; or 4×8 mm; or 4×7 mm; or 4×6 mm; or 4×5 mm; or 5×10 mm; or 5×9 mm; or 5×8 mm; or 5×7 mm; or 5×6 mm; or 6×10 mm; or 6×9 mm; or 6×8 mm; or 6×7 mm; or 7×10 mm; or 7×9 mm; or 7×8 mm; or 8×10 mm; or 8×9 mm; or 9×10 mm; or 3 mm; or 4 mm; or 5 mm; or 6 mm; or 7 mm; or 8 mm; or 9 mm; or 10 mm.

It is to be understood that the pore size of the fine mesh cathode and/or coarse mesh cathode is dependent on the geometry of the pore. For example, the geometry of the pore may be diamond shaped or square shaped. For the diamond shaped geometry, the pore size may be, e.g., 3×10 mm with 3 mm being widthwise and 6 mm being lengthwise of the diamond, or vice versa. For the square shaped geometry, the pore size would be, e.g., 3 mm each side.

In some embodiments, the electrochemical cell may include only the fine mesh cathode as the cathode component. In some embodiments, the electrochemical cell includes both the fine mesh cathode and the coarse mesh cathode as the cathode component, e.g., where fine mesh cathode is supported on the coarse mesh cathode and where only the fine mesh cathode is coated with the active catalyst, such as, platinum group metal, including platinum, palladium, nickel, or combination thereof. In some embodiments, the fine mesh cathode is coated with a platinum catalyst, such as, but not limited to, platinum black, platinum oxide, or combination thereof. In some embodiments, the fine mesh cathode and/or coarse mesh cathode is made of material including, but not limited to, metal, metal oxides, or combination thereof. Examples of metal include, but not limited to, stainless steel, nickel, iron, cobalt, copper, silver, gold, platinum, palladium, alloys of such metals, intermetallics with boron or phosphorus. Examples of metal oxides include, but not limited to, magnesium oxide, or combination thereof. In some embodiments, the fine mesh cathode and the coarse mesh cathode are made of nickel where the fine mesh cathode is coated with the active catalyst. In some embodiments, the fine mesh cathode and the coarse mesh cathode are made of stainless steel. In some embodiments, the fine mesh cathode is made of nickel coated with platinum and the coarse mesh cathode is made of stainless steel. In some embodiments, the fine mesh cathode is made of stainless steel coated with platinum and the coarse mesh cathode is made of nickel.

In some embodiments, the fine mesh cathode and/or the coarse mesh cathode include a mesh, a perforated plate, a bent plate, a plate with undulations, a plate with wavy fin like structure, or the like. In some embodiments, the fine mesh cathode and/or the coarse mesh cathode include a woven mesh or an expanded mesh. The woven mesh may be the mesh with square shaped pores and the expanded mesh may be the mesh with diamond shaped pores. In some embodiments, the fine mesh cathode has pores with a diamond shaped geometry or a square shaped geometry. In some embodiments, the coarse mesh cathode has pores with a diamond shaped geometry or a square shaped geometry. In some embodiments, when both the fine mesh cathode and the coarse mesh cathode are present, the fine mesh cathode has pores with the square shaped geometry and the coarse mesh cathode has pores with the diamond shaped geometry. In some embodiments, when both the fine mesh cathode and the coarse mesh cathode are present, the fine mesh cathode has pores with the diamond shaped geometry and the coarse mesh cathode has pores with the square shaped geometry. In some embodiments, where the cathode component has both the fine mesh cathode and the coarse mesh cathode, the two cathodes are separated by a spacer such as a mattress. In some embodiments, the mattress may be a coil, a flat mesh, a mesh with uneven surface or undulation, and the like. The mattress separates the fine mesh cathode from the coarse mesh cathode. In some embodiments, the mattress is made of nickel or the like.

In some embodiments, the wire thickness of the fine mesh cathode is less than 3 mm; or less than 2 mm; or less than 1 mm; or between 0.001-2.9 mm; or between 0.001-2.5 mm; or between 0.001-2 mm; or between 0.001-1 mm; or between 0.001-0.5 mm; or between 0.01-2.9 mm; or between 0.01-2.5 mm; or between 0.01-2 mm; or between 0.01-1 mm; or between 0.01-0.5 mm; or between 0.1-2.9 mm; or between 0.1-2.5 mm; or between 0.1-2 mm; or between 0.1-1 mm; or between 0.1-0.5 mm; or between 0.2-2.9 mm; or between 0.2-2.5 mm; or between 0.2-2 mm; or between 0.2-1 mm; or between 0.2-0.5 mm; or between 0.3-2.9 mm; or between 0.3-2.5 mm; or between 0.3-2 mm; or between 0.3-1 mm; or between 0.3-0.5 mm; or between 0.4-2.9 mm; or between 0.4-2.5 mm; or between 0.4-2 mm; or between 0.4-1 mm; or between 0.4-0.5 mm; or between 0.5-2.9 mm; or between 0.5-2.5 mm; or between 0.5-2 mm; or between 0.5-1 mm; or between 1-2.9 mm; or between 1-2 mm; or between 2-2.9 mm; or between 0.2×2.9 mm; or between 0.2×2 mm; or between 0.2×1 mm; or between 0.5×2.9 mm; or between 0.5×2 mm; or between 0.5×1 mm; or between 1×2.9 mm; or between 1×2 mm; or between 1×1.5 mm; or between 2×2.9 mm; or between 2×2.5 mm; or 2.9 mm; or 2 mm; or 1 mm; or 0.5 mm; or 0.4 mm; or 0.3 mm; or 0.2 mm; or 0.1 mm; or 0.05 mm.

In some embodiments, the wire thickness of the coarse mesh cathode is more than 3 mm; or more than 4 mm; or more than 5 mm; or more than 6 mm; or more than 7 mm; or more than 8 mm; or more than 9 mm; or more than 10 mm; between 3-10 mm; or between 3-9 mm; or between 3-8 mm; or between 3-7 mm; or between 3-6 mm; or between 3-5 mm; or between 3-4 mm; or between 4-10 mm; or between 4-9 mm; or between 4-8 mm; or between 4-7 mm; or between 4-6 mm; or between 4-5 mm; or between 5-10 mm; or between 5-9 mm; or between 5-8 mm; or between 5-7 mm; or between 5-6 mm; or between 6-10 mm; or between 6-9 mm; or between 6-8 mm; or between 6-7 mm; or between 7-10 mm; or between 7-9 mm; or between 7-8 mm; or between 8-10 mm; or between 8-9 mm; or between 9-10 mm; or 3 mm; or 4 mm; or 5 mm; or 6 mm; or 7 mm; or 8 mm; or 9 mm; or 10 mm.

In some embodiments, the fine mesh cathode has percent open area of between 10% to 95%; or between 10% to 85%; or between 10% to 75%; or between 10% to 65%; or between 10% to 55%; or between 10% to 45%; or between 10% to 35%; or between 10% to 25%; or between 10% to 15%; or between 20% to 95%; or between 20% to 85%; or between 20% to 75%; or between 20% to 65%; or between 20% to 55%; or between 20% to 45%; or between 20% to 35%; or between 20% to 25%; or between 30% to 95%; or between 30% to 85%; or between 30% to 75%; or between 30% to 65%; or between 30% to 55%; or between 30% to 45%; or between 30% to 35%; or between 40% to 95%; or between 40% to 85%; or between 40% to 75%; or between 40% to 65%; or between 40% to 55%; or between 40% to 45%; or between 50% to 95%; or between 50% to 85%; or between 50% to 75%; or between 50% to 65%; or between 50% to 55%; or between 60% to 95%; or between 60% to 85%; or between 60% to 75%; or between 60% to 65%; or between 70% to 95%; or between 70% to 85%; or between 70% to 75%; or between 80% to 95%; or between 80% to 85%; or between 90% to 95%; or 10%; or 20%; or 30%; or 40%; or 50%; or 60%; or 70%; or 80%; or 90%.

In some embodiments, the fine mesh cathode reduces voltage applied across the anode and the cathode as compared to the voltage with a coarse mesh cathode. As used herein, the “voltage” includes a current applied to an electrochemical cell that drives a desired reaction between the anode and the cathode in the electrochemical cell. In some embodiments, the desired reaction may be the electron transfer between the anode and the cathode such that an alkaline solution is formed in the cathode electrolyte. The voltage may be applied to the electrochemical cell by any means for applying the current across the anode and the cathode of the electrochemical cell. Such means are well known in the art and include, without limitation, devices, such as, electrical power source, fuel cell, device powered by sun light, device powered by wind, and combination thereof. The type of electrical power source to provide the current can be any power source known to one skilled in the art. For example, in some embodiments, the voltage may be applied by connecting the anodes and the cathodes of the cell to an external direct current (DC) power source. The power source can be an alternating current (AC) rectified into DC. The DC power source may have an adjustable voltage and current to apply a requisite amount of the voltage to the electrochemical cell.

In some embodiments, the voltage applied to the electrochemical cell is at least 200 A/m²; at least 500 A/m²; or at least 1000 A/m²; or at least 1500 A/m²; or at least 2000 A/m²; or at least 2500 A/m²; or at least 3000 A/m²; or at least 3500 A/m²; or at least 4000 A/m²; or at least 4500 A/m²; or at least 5000 A/m²; or between 200-5000 A/m²; or between 200-4500 A/m²; or between 200-4000 A/m²; or between 200-3500 A/m²; or between 200-3000 A/m²; or between 200-2500 A/m²; or between 200-2000 A/m²; or between 200-1500 A/m²; or between 200-1000 A/m²; or between 200-500 A/m²; or between 500-5000 A/m²; or between 500-4500 A/m²; or between 500-4000 A/m²; or between 500-3500 A/m²; or between 500-3000 A/m²; or between 500-2500 A/m²; or between 500-2000 A/m²; or between 500-1500 A/m²; or between 500-1000 A/m²; or between 1000-5000 A/m²; or between 1000-4500 A/m²; or between 1000-4000 A/m²; or between 1000-3500 A/m²; or between 1000-3000 A/m²; or between 1000-2500 A/m²; or between 1000-2000 A/m²; or between 1000-1500 A/m²; or between 1500-5000 A/m²; or between 1500-4500 A/m²; or between 1500-4000 A/m²; or between 1500-3500 A/m²; or between 1500-3000 A/m²; or between 1500-2500 A/m²; or between 1500-2000 A/m²; or between 2000-5000 A/m²; or between 2000-4500 A/m²; or between 2000-4000 A/m²; or between 2000-3500 A/m²; or between 2000-3000 A/m²; or between 2000-2500 A/m²; or between 2500-5000 A/m²; or between 2500-4500 A/m²; or between 2500-4000 A/m²; or between 2500-3500 A/m²; or between 2500-3000 A/m²; or between 3000-5000 A/m²; or between 3000-4500 A/m²; or between 3000-4000 A/m²; or between 3000-3500 A/m²; or between 3500-5000 A/m²; or between 3500-4500 A/m²; or between 3500-4000 A/m²; or between 4000-5000 A/m²; or between 4000-4500 A/m²; or between 4500-5000 A/m².

In some embodiments, the fine mesh cathode reduces the voltage applied across the anode and the cathode by between 100 mV to 1000 mV; or between 100 mV to 900 mV; or between 100 mV to 800 mV; or between 100 mV to 700 mV; or between 100 mV to 600 mV; or between 100 mV to 500 mV; or between 100 mV to 400 mV; or between 100 mV to 300 mV; or between 100 mV to 200 mV; or between 200 mV to 1000 mV; or between 200 mV to 900 mV; or between 200 mV to 800 mV; or between 200 mV to 700 mV; or between 200 mV to 600 mV; or between 200 mV to 500 mV; or between 200 mV to 400 mV; or between 200 mV to 300 mV; or between 500 mV to 1000 mV; or between 500 mV to 900 mV; or between 500 mV to 800 mV; or between 500 mV to 700 mV; or between 500 mV to 600 mV; between 800 mV to 1000 mV; or between 800 mV to 900 mV. In some embodiments, the reduction in the voltage is about 100 mV for every 1 mm reduction in the pore size for the fine mesh cathode. In some embodiments, the fine mesh cathode reduces the voltage applied across the anode and the cathode by between 100 mV to 1000 mV as compared to the coarse mesh cathode.

In some embodiments, the fine mesh cathode reduces resistance provided by the cathode electrolyte thereby reducing the voltage applied across the anode and the cathode and/or thereby increasing the current density across the anode and the cathode. In some embodiments, the fine mesh cathode reduces resistance provided by the cathode electrolyte as compared to the resistance provided by the cathode electrolyte with a coarse mesh cathode. Without being bound by any theory, it is contemplated that the reduced resistance by the cathode electrolyte in the presence of the fine mesh cathode may be attributed to one or more of increase in active surface area, decrease in pore size, decrease in wire thickness, and/or percent open area, of the fine mesh cathode.

In some embodiments, the fine mesh cathode provides an enhancement in current density across the anode and the cathode. In some embodiments, the fine mesh cathode provides an enhancement in current density across the anode and the cathode as compared to the current density with a coarse mesh cathode. Without being bound by any theory, it is contemplated that the enhancement in the current density across the anode and the cathode in the presence of the fine mesh cathode may be attributed to one or more of increase in active surface area, decrease in pore size, decrease in wire thickness, and/or percent open area, of the fine mesh cathode.

In some embodiments, the fine mesh cathode reduces deformation of an ion exchange membrane disposed between the anode and the cathode. In some embodiments, the fine mesh cathode reduces deformation of an ion exchange membrane disposed between the anode and the cathode as compared to the deformation by a coarse mesh cathode. Without being bound by any theory, it is contemplated that the reduced pore size of the fine mesh cathode may attribute to the reduced deformation of the membrane when the membrane is pressed against the fine mesh cathode. It is contemplated that the higher pore size of the coarse mesh cathode may attribute to the increase in the deformation of the membrane when the membrane is pressed against the coarse mesh cathode.

Some embodiments of the methods and systems using the electrochemical cell are described herein. Such electrochemical cells are in no way limiting to the scope of the invention. It is to be understood that any electrochemical cell that produces an alkali in the cathode electrolyte is well within the scope of the invention.

### Methods and Systems Including an Electrochemical Cell

In one aspect, the methods and systems described herein include an electrochemical cell that includes the anode, the cathode including the fine mesh cathode, and the voltage applied across the anode and the cathode. In some embodiments, the electrochemical cell further includes a delivery system configured to deliver hydrogen gas to the anode. In some embodiments, the electrochemical cell further includes a device adapted to provide the voltage across the anode and the cathode. In some embodiments of the electrochemical cell, the hydrogen gas is formed at the cathode and is delivered to the anode. In some embodiments of the electrochemical cell, the anode does not form an oxygen gas and/or chlorine gas.

In one aspect, there is provided a system including an anode electrolyte in contact with an anode; a cathode electrolyte in contact with a cathode where the cathode is a fine mesh cathode; and a device to provide voltage across the anode and the cathode. In some embodiments, the system further includes a delivery system configured to deliver hydrogen gas to the anode. In some embodiments, the system further includes a contact system configured to contact the hydroxide generated at the cathode with carbon from a source of carbon.

In another aspect, there is provided an electrochemical cell system including an anode in contact with an anode electrolyte; a cathode in contact with a cathode electrolyte where the cathode is a fine mesh cathode; a hydrogen gas delivery system to deliver hydrogen gas to the anode; and a device adapted to provide voltage across the anode and the cathode. In some embodiments, the electrochemical cell system further includes a contact system configured to contact the cathode electrolyte with carbon from a source of carbon.

Accordingly, in some embodiments, there is provided an electrochemical cell system including an anode in contact with an anode electrolyte; a cathode in contact with a cathode electrolyte where the cathode is a fine mesh cathode; and a contact system configured to contact the cathode electrolyte with carbon from a source of carbon. In some embodiments, the electrochemical cell system further includes a device adapted to provide voltage across the anode and the cathode. In some embodiments, the electrochemical cell system further includes a hydrogen gas delivery system to deliver hydrogen gas to the anode.

The electrochemical methods and systems described herein produce hydroxide in the cathode electrolyte and an acid in the anode electrolyte. In some embodiments, the methods provided herein further include treating the hydroxide produced in the cathode electrolyte with carbon from a source of carbon including, but not limited to a gaseous stream of CO₂, solution containing CO₂, and/or bicarbonate brine solution. Such source of carbon is further described in detail herein. The carbon in the source of carbon includes, but not limited to, CO₂, carbonic acid, bicarbonate ions, carbonate ions, or combination thereof.

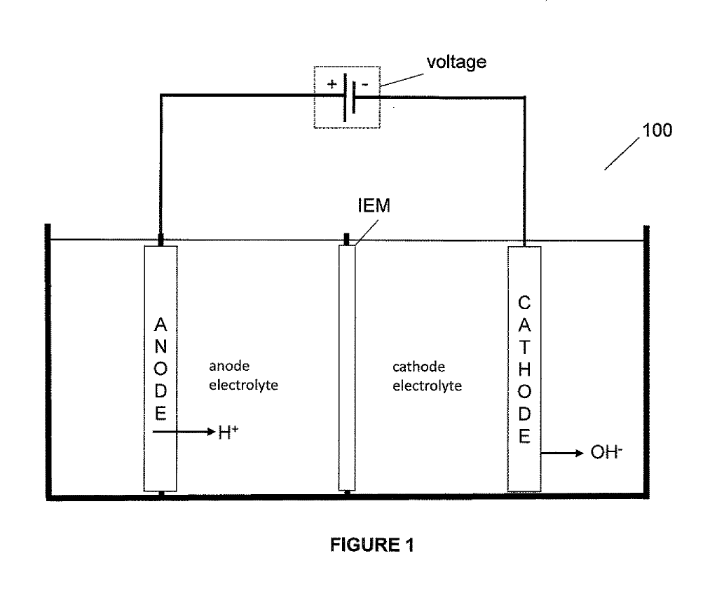

FIG. 1 illustrates an embodiment of the electrochemical systems and methods provided herein, where the system 100 includes an anode that is in contact with an anode electrolyte; a fine mesh cathode that is in contact with a cathode electrolyte. The system 100 also includes voltage applied across the anode and the cathode. The anode and the cathode electrolyte are separated by an ion exchange membrane (IEM). The cathode produces hydroxide ions in the cathode electrolyte.

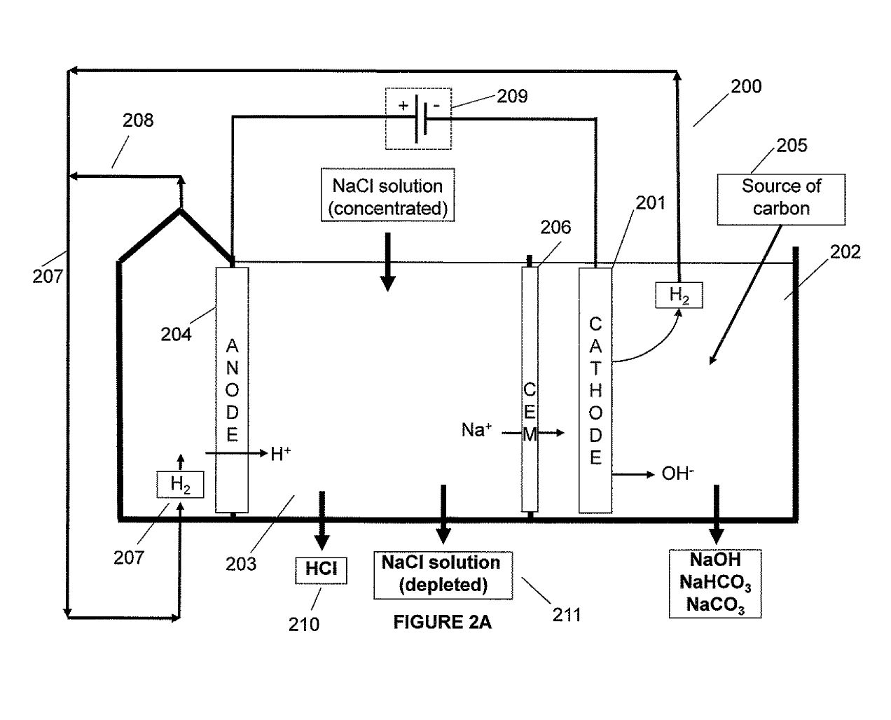

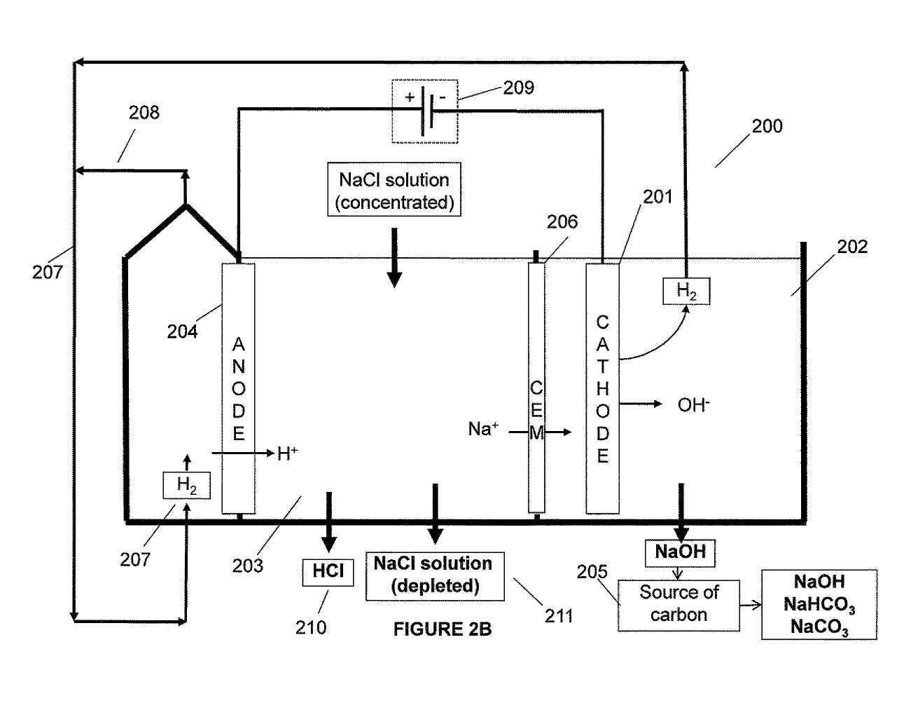

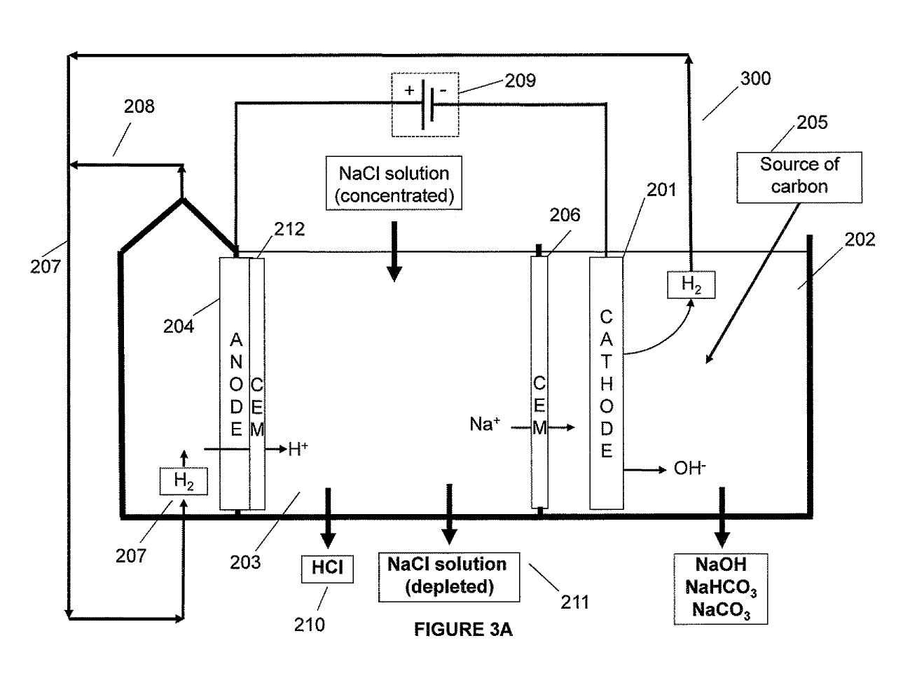

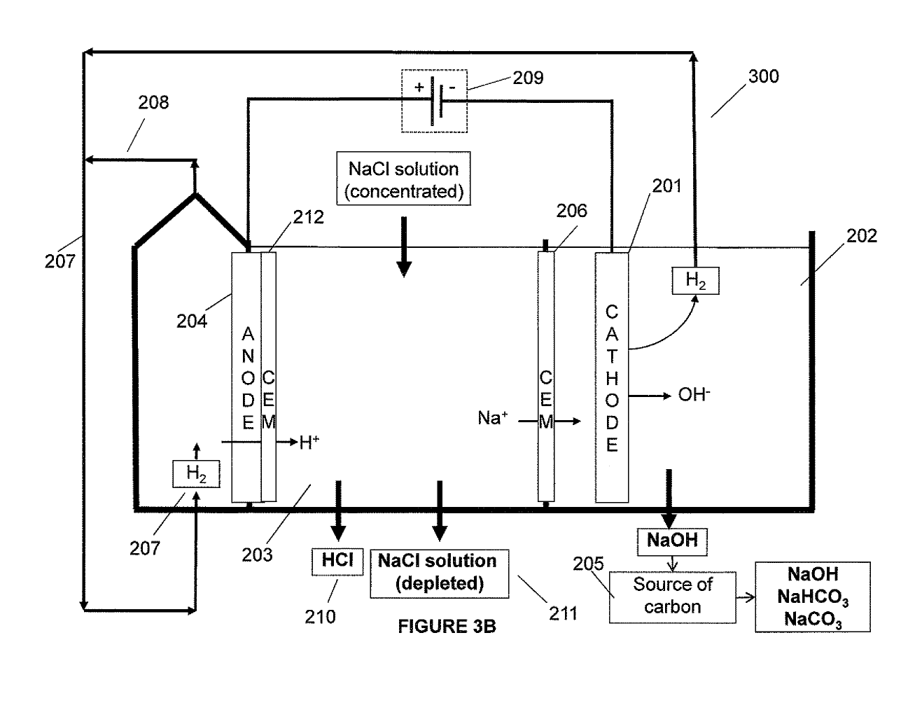

FIGS. 2A, 2B, 3A, and 3B illustrate some embodiments of the electrochemical systems and methods provided herein, where the systems 200 and 300 include a cathode chamber including a cathode 201 in contact with a cathode electrolyte 202 and an anode chamber including an anode 204 and an anode electrolyte 203. In some embodiments, the cathode 201 is the fine mesh cathode. In some embodiments, the cathode 201 is the fine mesh cathode supported on the coarse mesh cathode. In some embodiments, the cathode 201 is the fine mesh cathode and the coarse mesh cathode separated by a mattress such as a coil, spring, net, mesh or wire with undulations. In some embodiments, the mattress serves to support the fine mesh cathode and the coarse mesh cathode. The systems 200 and 300 also include a voltage 209 applied across the anode and the cathode. In FIGS. 2A, 2B, 3A, and 3B, the cathode chamber is separated from the anode chamber by a first cation exchange membrane (CEM) 206. FIGS. 3A and 3B illustrate the system 300 including an anode 204 that is separated from the anode electrolyte 203 by a second cation exchange membrane 212 that is in contact with the anode 204. FIGS. 2A and 3A illustrate some embodiments where the source of carbon 205 is added to the cathode electrolyte 202 inside the cathode chamber. FIGS. 2B and 3B illustrate some embodiments where the source of carbon 205 is contacted with the sodium hydroxide from the cathode electrolyte 202 outside the cathode chamber.

In systems 200 and 300 as illustrated in FIGS. 2A, 2B, 3A, and 3B, the first cation exchange membrane 206 is located between the cathode 201 and the anode 204 such that it separates the cathode electrolyte 202 from the anode electrolyte 203. In some embodiments, the hydrogen gas produced at the cathode is directed to the anode through a hydrogen gas delivery system 207, and is oxidized to hydrogen ions at the anode.

In some embodiments, during the start-up cycle of the electrochemical cell illustrated in FIGS. 2A, 2B, 3A, and 3B, the anode chamber is filled with the anode electrolyte 203. The hydrogen gas from an external source is delivered to the anode 204. The cathode chamber is filled with the cathode electrolyte 202 after or simultaneously or before the anode chamber is filled with the anode electrolyte. The voltage 209 is applied across the anode 204 and the cathode 201. After turning on the voltage 209, the source of carbon 205 may be contacted with the cathode electrolyte inside the cathode chamber and/or outside the cathode chamber, to react the hydroxide ions produced at the cathode with the carbon in the source of carbon.

As is illustrated in FIGS. 2A, 2B, 3A, and 3B, on applying a relatively low voltage 209, e.g., less than 2V or less than 1V, across the anode 204 and the cathode 201, hydroxide ions (OH⁻) and hydrogen gas (H₂) are produced at the fine mesh cathode 201; the hydrogen gas is directed from the cathode 201 to the anode 204; and hydrogen gas is oxidized at the anode 204 to produce hydrogen ions at the anode 204, without producing a gas at the anode. In some embodiments, utilizing hydrogen gas at the anode from hydrogen generated at the cathode eliminates the need for an external supply of hydrogen. In some embodiments, utilizing hydrogen gas at the anode from hydrogen generated at the cathode reduces the utilization of energy by the system to produce the alkaline solution.

In some embodiments, as illustrated in FIGS. 2A, 2B, 3A, and 3B, under the applied voltage 209 across the anode 204 and the cathode 201, hydroxide ions are produced at the cathode 201 and are migrated into the cathode electrolyte 202, and hydrogen gas is produced at the cathode. In certain embodiments, the hydrogen gas produced at the cathode 201 is collected and directed to the anode, e.g., by a hydrogen gas delivery system 207, where it is oxidized to produce hydrogen ions at the anode. Under the applied voltage 209 across the anode 204 and cathode 201, hydrogen ions produced at the anode 204 migrate from the anode 204 into the anode electrolyte 203 to produce an acid, e.g., hydrochloric acid. In some embodiments, the first cation exchange membrane 206 may be selected to allow passage of cations therethrough while restricting passage of anions therethrough. Thus, as is illustrated in FIGS. 2A, 2B, 3A, and 3B, on applying the low voltage across the anode 204 and cathode 201, cations in the anode electrolyte 203, e.g., sodium ions in the anode electrolyte migrate into the cathode electrolyte through the first cation exchange membrane 206, while anions in the cathode electrolyte 202, e.g., hydroxide ions, and/or carbonate ions, and/or bicarbonate ions, are prevented from migrating from the cathode electrolyte through the first cation exchange membrane 206 and into the anode electrolyte 203.

Thus, as is illustrated in FIGS. 2A, 2B, 3A, and 3B, where the anode electrolyte 203 includes an aqueous salt solution such as sodium chloride in water, a solution, e.g., an alkaline solution, is produced in the cathode electrolyte 202 including cations, e.g., sodium ions, that migrate from the anode electrolyte 203, and anions, e.g., hydroxide ions produced at the cathode 201. As illustrated in FIGS. 2A and 3A, in some embodiments, the source of carbon 205 may be contacted with the cathode electrolyte 202 inside the cathode chamber. Concurrently, in the anode electrolyte 203, an acid, e.g., hydrochloric acid is produced from hydrogen ions migrating from the anode 204 and anions, e.g., chloride ions, present from the anode electrolyte. As illustrated in FIGS. 2B and 3B, in some embodiments, the source of carbon 205 may be contacted with the cathode electrolyte 202 containing sodium hydroxide outside the cathode chamber. The carbon in the source of carbon upon reaction with the sodium hydroxide in the cathode electrolyte produces bicarbonate and/or carbonate ions. Such carbonate/bicarbonate containing solution is further processed as described herein to make carbonate compositions.

With reference to FIGS. 3A and 3B, an anode comprising a second cation exchange membrane 212 is utilized to separate the anode 204 from the anode electrolyte 203 such that on a first surface, the cation exchange membrane 212 is in contact with the anode 204, and on an opposed second surface, it is in contact with the anode electrolyte 203. In some embodiments, since the second cation exchange membrane 212 is permeable to cations, e.g., hydrogen ions, the anode 204 is in electrical contact with the anode electrolyte 203 through the second cation exchange membrane 212.

Thus, in some embodiments of FIGS. 3A and 3B, as with the embodiments illustrated for FIGS. 2A and 2B, on applying the low voltage across the anode 204 and the cathode 201, hydrogen ions, produced at the anode 204 from oxidation of hydrogen gas at the anode, migrate through the second cation exchange membrane 212 into the anode electrolyte 203. At the same time, cations in the anode electrolyte 203, e.g., sodium ions in the anode electrolyte comprising sodium chloride, migrate from the anode electrolyte 203 into the cathode electrolyte 202 through the first cation exchange membrane 206, while anions in the cathode electrolyte 202, e.g., hydroxide ions, and/or carbonate ions, and/or bicarbonate ions, are prevented from migrating from the cathode electrolyte 202 to the anode electrolyte 203 through the first cation exchange membrane 206. Also, in some embodiments of FIGS. 3A and 3B, hydrogen ions migrating from the anode 204 through the second cation exchange membrane 212 into the anode electrolyte 203 may produce an acid, e.g., hydrochloric acid with the anions, e.g., chloride ions, present in the anode electrolyte; wherein the cathode electrolyte 202, an alkaline solution is produce from anions present in the cathode electrolyte 202 and cations, e.g., sodium ions, that migrate from the anode electrolyte 203 to the cathode electrolyte 202 through the first cation exchange membrane 206. In some embodiments, the voltage across the anode 204 and the cathode 201 is adjusted to a level such that hydroxide ions and hydrogen gas are produced at the cathode 201 without producing a gas, e.g., chlorine or oxygen, at the anode 204.

As illustrated in FIGS. 2A and 3A, in some embodiments, the cathode electrolyte 202 is operatively contacted with a source of carbon 205. In some embodiments, the source of carbon is gaseous stream of CO₂. In some embodiments, the source of carbon is a solution containing dissolved form of CO₂. In some embodiments, the source of carbon is naturally occurring bicarbonate brine. In some embodiments, the source of carbon may be brine processed from other brines to produce the bicarbonate brine solution. In some embodiments, the bicarbonate brine solution is produced from freshwater, brine, or brackish water by adding bicarbonate ions to it. Such sources of carbon have been described in detail herein.

As illustrated in FIGS. 2A, 2B, 3A, and 3B, in some embodiments, the anode electrolyte 203 comprises a salt solution that includes sodium ions and chloride ions; the system 200, 300 is configured to produce the alkaline solution in the cathode electrolyte 202 while also producing hydrogen ions at the anode 204, with less than 2V, or less than 1V, or between 0.1V-1V, or between 0.1-2V, of the voltage 209 across the anode 204 and the cathode 201 including the fine mesh cathode, without producing a gas at the anode 204; the system 200, 300 is configured to migrate hydrogen ions from the anode 204 into the anode electrolyte 203; the anode electrolyte 203 comprises an acid; the system 200, 300 is configured to produce hydroxide, and/or bicarbonate ions, and/or carbonate ions in the cathode electrolyte 202; migrate hydroxide ions from the cathode 201 into the cathode electrolyte 202; migrate cations, e.g., sodium ions, from the anode electrolyte 203 into the cathode electrolyte 202 through the first cation exchange membrane 206; provide hydrogen gas to the anode; a hydrogen gas delivery system 207 is configured to direct hydrogen gas from the cathode to the anode; the cathode electrolyte 202 in the system 200, 300 is configured to be contacted with a source of carbon 205 inside the cathode chamber to produce bicarbonate, carbonate, or mixture thereof depending on the pH of the cathode electrolyte; in some embodiments, the sodium hydroxide produced by the cathode electrolyte 202 is contacted with the carbon in the source of carbon 205 outside the cathode chamber to produce bicarbonate, carbonate, or mixture thereof.

In some embodiments, during the shut-down cycle of the electrochemical cell illustrated in FIGS. 2A, 2B, 3A, and 3B, the voltage 209 is turned off followed by stopping of the flow of the electrolytes to the cell. The cells are allowed to cool down. The delivery of the hydrogen gas to the anode is stopped. The cell chambers are allowed to undergo drainage of the electrolytes. The cell chambers are optionally flushed with DI water.

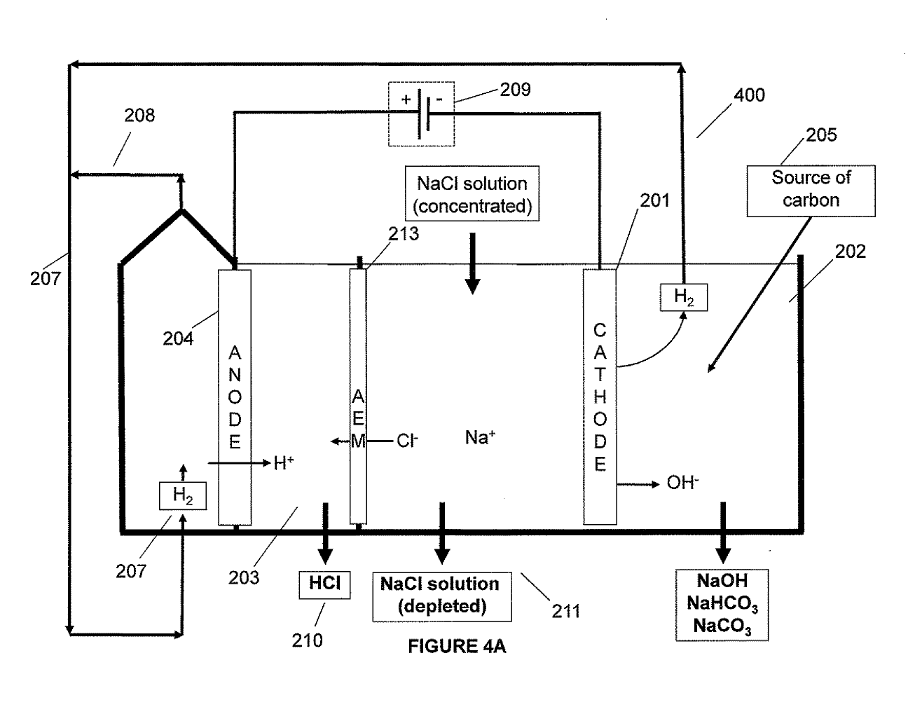

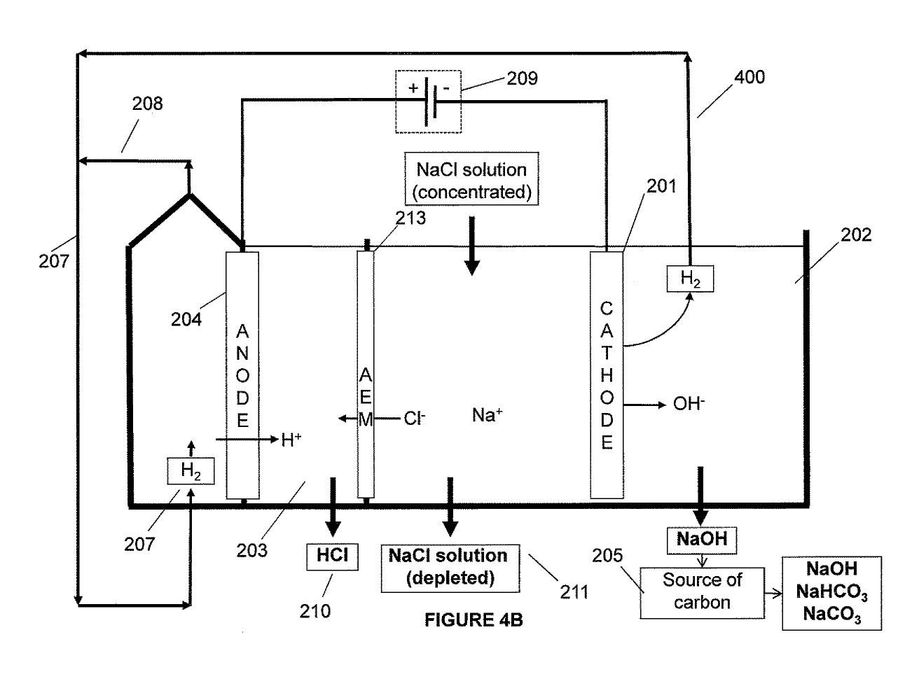

In some embodiments, as illustrated in FIGS. 4A and 4B, the system 400 comprises a cathode chamber including a cathode 201 in contact with a cathode electrolyte 202 and an anode chamber including an anode 204 in contact with an anode electrolyte 203. In some embodiments, the cathode 201 is the fine mesh cathode. In some embodiments, the cathode 201 is the fine mesh cathode supported on the coarse mesh cathode. In some embodiments, the cathode 201 is the fine mesh cathode and the coarse mesh cathode separated by a mattress such as a coil, spring, net, mesh or wire with undulations. In some embodiments, the mattress serves to support the fine mesh cathode and the coarse mesh cathode. In this system, the cathode electrolyte 202 comprises a salt solution that functions as the cathode electrolyte as well as a source of chloride and sodium ions for the alkaline and acid solution produced in the system. In this system, the cathode electrolyte 202 is separated from the anode electrolyte 203 by an anion exchange membrane (AEM) 213 that allows migration of anions, e.g., chloride ions, from the salt solution to the anode electrolyte 203. As is illustrated in FIGS. 4A and 4B, the system includes a hydrogen gas delivery system 207 configured to provide hydrogen gas to the anode 204. The system 400 also includes a voltage 209 applied across the anode and cathode.

Referring to FIGS. 4A and 4B, on applying a voltage 209 across the anode and cathode, protons produced at the anode 204 from oxidation of hydrogen enter into the anode electrolyte 203 from where they may attempt to migrate to the cathode electrolyte 202 across the anion exchange membrane 213. However, as the anion exchange membrane 213 may block the passage of cations, the protons may accumulate in the anode electrolyte 203. At the same time, however, the anion exchange membrane 213 being pervious to anions may allow the migration of anions, e.g., chloride ions from the cathode electrolyte 202 to the anode electrolyte 203. Thus, in some embodiments, chloride ions may migrate to the anode electrolyte 203 to produce hydrochloric acid in the anode electrolyte 203. In this system, the voltage 209 across the anode 204 and the cathode 201 is adjusted to a level such that hydroxide ions and hydrogen gas are produced at the cathode 201 without producing a gas, e.g., chlorine or oxygen, at the anode 204. In some embodiments, since cations may not migrate from the cathode electrolyte across the anion exchange membrane 213, sodium ions may accumulate in the cathode electrolyte 202 to produce an alkaline solution with hydroxide ions produced at the cathode. In some embodiments where carbon from the source of carbon is contacted with the cathode electrolyte, sodium ions may also produce sodium bicarbonate and/or sodium carbonate in the cathode electrolyte.

As illustrated in FIGS. 4A and 4B, in some embodiments, the anode electrolyte 203 comprises a salt solution that includes sodium ions and chloride ions; the system 400 is configured to produce the alkaline solution in the cathode electrolyte 202 while also producing hydrogen ions at the anode 204, with less than 1V across the anode 204 and the cathode 201 including the fine mesh cathode, without producing a gas at the anode 204; the system 400 is configured to migrate chloride ions from the cathode electrolyte 202 to the anode electrolyte 203 through the anion exchange membrane 213; hydrogen gas is provided to the anode; and a hydrogen gas delivery system 207 is configured to direct hydrogen gas from the cathode to the anode; the anode electrolyte 203 comprises an acid; migrate hydroxide ions from the cathode 201 into the cathode electrolyte 202; the system 400 is configured to produce hydroxide, and/or bicarbonate ions, and/or carbonate ions in the cathode electrolyte 202.

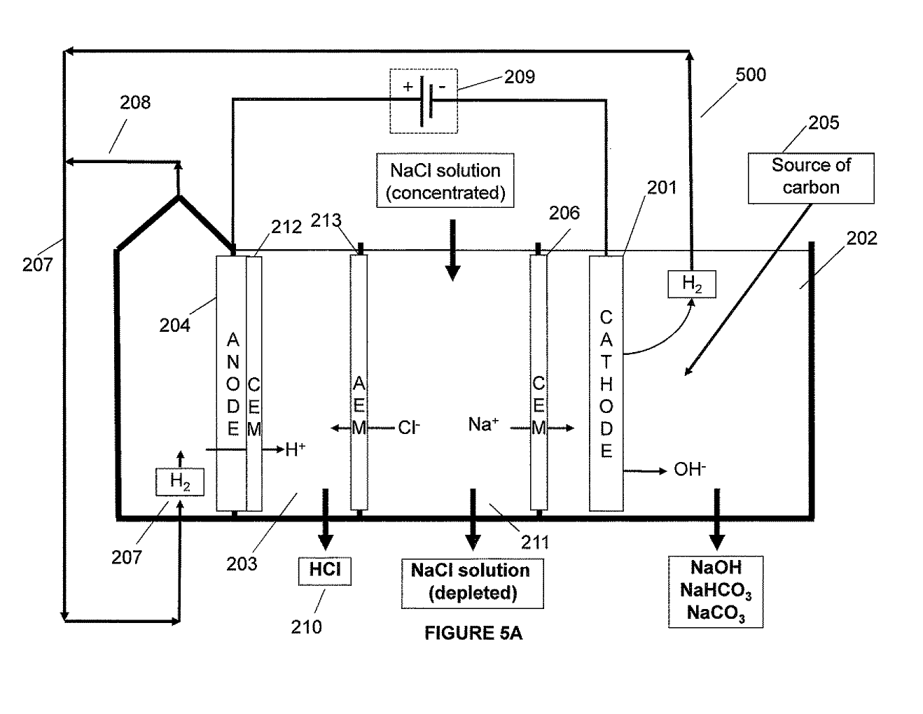

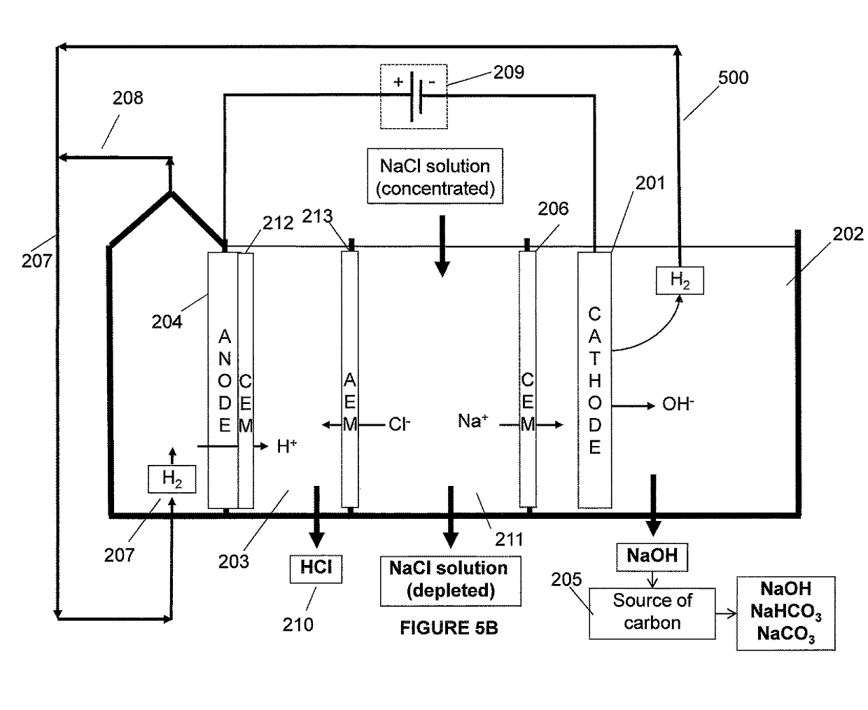

Referring to FIGS. 5A and 5B herein, the system 500 in some embodiments includes an anode chamber including an anode 204 in contact with an anode electrolyte 203 and a cathode chamber including a cathode 201 in contact with a cathode electrolyte 202. In some embodiments, the cathode 201 is the fine mesh cathode. In some embodiments, the cathode 201 is the fine mesh cathode supported on the coarse mesh cathode. In some embodiments, the cathode 201 is the fine mesh cathode and the coarse mesh cathode separated by a mattress such as a coil, spring, net, mesh or wire with undulations. In some embodiments, the mattress serves to support the fine mesh cathode and the coarse mesh cathode. The system 500 includes a third electrolyte disposed between the anion exchange membrane 213 and the first cation exchange membrane 206. The third electrolyte is a salt solution 211. The system 500 also includes a voltage 209 applied across the anode and cathode. In some embodiments, the system includes a gas delivery system 207 configured to deliver hydrogen gas to the anode 204. In some embodiments, the hydrogen gas is obtained from the cathode 201. In the system, the anode 204 is configured to produce protons, and the cathode 201 is configured to produce hydroxide ions and hydrogen gas when a low voltage 209, e.g., less than 2V, is applied across the anode and the cathode. In the system, a gas is not produced at the anode 204.

In some embodiments, the system is as illustrated in FIGS. 5A and 5B, the first cation exchange membrane 206 is positioned between the cathode electrolyte 202 and the third electrolyte, the salt solution 211; and an anion exchange membrane 213 is positioned between the salt solution 211 and the anode electrolyte 203 in a configuration where the anode electrolyte 203 is separated from the anode 204 by second cation exchange membrane 212. In some embodiments, the second cation exchange membrane is optional. The second cation exchange membrane may prevent the anode from corrosion by the acid generated in the anode electrolyte. Therefore, systems where the anode does not have a second cation exchange membrane, are well within the scope of the invention. In the system, the second cation exchange membrane 212 is positioned between the anode 204 and the anode electrolyte 203 such that anions may migrate from the salt solution 211 to the anode electrolyte 203 through the anion exchange membrane 213; however, anions are prevented from contacting the anode 204 by the second cation exchange membrane 212 adjacent to the anode 204. It is to be understood that there may be more than one anion exchange membranes and cation exchange membranes in the system depending on the desired configuration of the electrochemical cell.

In some embodiments, the system is configurable to migrate anions, e.g., chloride ions, from the salt solution 211 to the anode electrolyte 203 through the anion exchange membrane 213; migrate cations, e.g., sodium ions from the salt solution 211 to the cathode electrolyte 202 through the first cation exchange membrane 206; migrate protons from the anode 204 to the anode electrolyte 203; and migrate hydroxide ions from the cathode 201 to the cathode electrolyte 202. In some embodiments, the system may be configured to contact carbon from the source of carbon 205 with the cathode electrolyte inside the cathode chamber (FIG. 5A) or outside the cathode chamber (FIG. 5B). Thus, in some embodiments, the system may be configured to produce sodium hydroxide and/or sodium bicarbonate and/or sodium carbonate in the cathode electrolyte 202; and produce an acid e.g., hydrochloric acid 210 in the anode electrolyte 203.

In some embodiments for FIGS. 5A and 5B, on applying the voltage 209 across the anode and the cathode, the system can be configured to produce hydroxide ions and hydrogen gas at the fine mesh cathode 201; migrate hydroxide ions from the fine mesh cathode into the cathode electrolyte 202; migrate cations from the salt solution 211 to the cathode electrolyte 202 through the first cation exchange membrane 206; migrate chloride ions from the salt solution 211 to the anode electrolyte 203 through the anion exchange membrane 213; and migrate protons from the anode 204 to the anode electrolyte 203. Hence, depending on the salt solution 211 used, the system can be configured to produce an alkaline solution, e.g., sodium hydroxide in the cathode electrolyte. The first cation exchange membrane 206 may block the migration of anions from the cathode electrolyte 202 to the salt solution 211, causing the hydroxide ions to accumulate in the cathode electrolyte. The anion exchange membrane 213 may block the migration of cations, e.g., protons from the anode electrolyte 203 to the salt solution 211 causing the protons to accumulate in the anode electrolyte. With reference to FIGS. 5A and 5B, the system in some embodiments includes a second cation exchange membrane 212, attached to the anode 204, such that it separates the anode 204 from the anode electrolyte 203. In this configuration, as the second cation exchange membrane 212 is permeable to cations, protons formed at the anode migrate to the anode electrolyte as described herein; however, as the second cation exchange membrane 212 is impermeable to anions, e.g., chloride ions, in the anode electrolyte may be blocked from migrating to the anode 204, thereby avoiding interaction between the anode and the anions that may interact with the anode, e.g., by corrosion.

In the system as illustrated in FIGS. 5A and 5B, with the voltage 209 across the anode and the cathode, since the salt solution is separated from the cathode electrolyte by the first cation exchange membrane 206, cations in the salt solution, e.g., sodium ions, migrate through the first cation exchange membrane 206 to the cathode electrolyte 202, and anions, e.g., chloride ions, migrate to the anode electrolyte 203 through the anion exchange membrane 213. Consequently, in the system, as illustrated in FIGS. 5A and 5B, an acid, e.g., hydrochloric acid 210 may be produced in the anode electrolyte 203, and alkaline solution, e.g., sodium hydroxide may be produced in the cathode electrolyte. With the migration of cations and anions from the salt solution, the system in some embodiments can be configured to produce a partly de-ionized salt solution from the salt solution 211. In some embodiments, this partially de-ionized salt solution can be used as feed-water to a desalination facility (not shown) where it can be further processed to produce desalinated water as described in commonly assigned U.S. Patent Application Publication no. US 2009/0001020, filed on Jun. 27, 2008, herein incorporated by reference in its entirety. In some embodiments, the solution can be used in industrial and agricultural applications where its salinity is acceptable. In some embodiments, the partially de-ionized salt solution may be transferred to the anode chamber (not shown in the figure) to form or mix into the anode electrolyte 203.

In some embodiments, the systems provided herein may further include a percolator between the anode 204 and the CEM 206 and/or between the cathode 201 and the CEM 206, in FIGS. 2A and 2B; between the second CEM 212 and the first CEM 206 and/or between the first CEM 206 and the cathode 201, in FIGS. 3A and 3B; between the anode 204 and the AEM 213 and/or between the cathode 201 and AEM 213, in FIGS. 4A and 4B; between the second CEM 212 and AEM 213 and/or between first CEM 206 and AEM 213, as in FIGS. 5A and 5B; and/or between the anode 204 and the AEM 213 and/or between the AEM 213 and first CEM 206, as in FIGS. 5A and 5B but without the second CEM. A “percolator” as used herein, includes any porous planar element suitable for being traversed by a liquid flow. The percolator may assist in even distribution of the anode electrolyte, cathode electrolyte, and/or salt solution depending on its location. The percolator may also assist in providing a mechanical support to the anode, cathode and/or ion exchange membranes. For example, the percolator may help the CEM be pushed against the anode and/or the cathode with a certain pressure so as to allow the electrical continuity while contributing to the confinement of the circulating liquid electrolyte.

In some embodiments, the percolator may be designed so as to impose a controlled pressure drop to the falling electrolyte column, so that a resulting operative pressure not sufficient to flood the electrode is exerted on every point of the same. The pressure with which the percolator may be pushed against the anode and/or cathode may be in a range of 0.01 to 2 kg/cm²; or 0.01 to 1.5 kg/cm²; or 0.01 to 1 kg/cm²; or 0.01 to 0.5 kg/cm²; or 0.01 to 0.05 kg/cm²; or 0.1 to 2 kg/cm²; or 0.1 to 1.5 kg/cm²; or 0.1 to 1 kg/cm²; or 0.1 to 0.5 kg/cm²; or 0.5 to 2 kg/cm²; or 0.5 to 1.5 kg/cm²; or 0.5 to 1 kg/cm²; or 1 to 2 kg/cm²; or 1 to 1.5 kg/cm²; or 1.5 to 2 kg/cm². The percolator can be a mesh, cloth, foam, sponge, a planar mesh formed by the overlapping of planes of interwoven wires, a mattress formed by coils of wires, an expanded sheet, a sintered body, or combinations or juxtapositions of two or more of such elements. In some embodiments, the percolator has hydrophobic characteristics or hydrophilic characteristics as is suitable for the cell. The percolator may be made of a metal such as, for example, a nickel foam or may be a corrosion resistant plastic material, such as, for example, a perfluorinated material, e.g., poly-tetrafluoroethylene (PTFE).

In some embodiments, the thickness of the percolator is between 0.1 mm to 5 mm; or 0.1 mm to 4 mm; or 0.1 mm to 3.5 mm; or 0.1 mm to 3 mm; or 0.1 mm to 2.5 mm; or 0.1 mm to 2 mm; or 0.1 mm to 1.5 mm; or 0.1 mm to 1 mm; or 0.1 mm to 0.5 mm; or 0.5 mm to 5 mm; or 0.5 mm to 4 mm; or 0.5 mm to 3 mm; or 0.5 mm to 2 mm; or 0.5 mm to 1 mm; or 1 mm to 5 mm; or 1 mm to 4 mm; or 1 mm to 3 mm; or 1 mm to 2 mm; or 2 mm to 5 mm; or 2 mm to 4 mm; or 2 mm to 3 mm; or 3 mm to 5 mm; or 3 mm to 4 mm; or 4 mm to 5 mm; or more than 0.1 mm; or less than 0.1 mm. One skilled in the art can identify preferred thicknesses and geometries of the mesh or cloth depending on the electrolyte density, the height of the hydraulic head to be discharged and/or the required fluid dynamic conditions.

In some embodiments, the systems provided herein may further include a spacer between the anode 204 and the CEM 206 and/or between the cathode 201 and the CEM 206, as in FIGS. 2A and 2B; between the second CEM 212 and the first CEM 206 and/or between the first CEM 206 and the cathode 201, as in FIGS. 3A and 3B; between the anode 204 and the AEM 213 and/or between the cathode 201 and the AEM 213, as in FIGS. 4A and 4B; between the second CEM 212 and AEM 213, and/or between the first CEM 206 and AEM 213, as in FIGS. 5A and 5B; and/or between the anode 204 and the AEM 213 and/or between the first CEM 206 and AEM 213, as in FIGS. 5A and 5B but without the second CEM. A “spacer” as used herein, includes any porous planar element suitable for being traversed by a liquid flow. The spacer may assist in holding the electrode and/or membrane apart from one another and may or may not insulate portions of the electrode from the electrolyte. In some embodiments, the spacer may be insulative and be extended in width to act as inlet and exit channels for adjacent cells, and thereby offer resistance to current leakage. Examples of the insulative spacer include, but not limited to, ECTFE (ethylene chlorotrifluoroethylene), FEP (fluorinated ethylene propylene), MFA (fluoroalkoxy), PFA (perfluoroalkoxy), teflon, or the like. In some embodiments, the spacer may be conductive and may be made of metals such as, but not limited to, titanium, nickel, aluminum, alloys thereof or other suitable materials. In some embodiments, the spacer in the electrochemical cell is both insulative and conductive type. In some embodiments, the spacer is a paper, e.g., PDBE100. The spacer may be installed in the cell in one single piece or may be installed in the cell as several pieces. The spacer can be a mesh, cloth, foam, sponge, a planar mesh formed by the overlapping of planes of interwoven wires, a mattress formed by coils of wires, an expanded sheet, a sintered body, or combinations or juxtapositions of two or more of such elements.

In some embodiments, the thickness of the spacer is between 0.1 mm to 5 mm; or 0.1 mm to 4 mm; or 0.1 mm to 3.5 mm; or 0.1 mm to 3 mm; or 0.1 mm to 2.5 mm; or 0.1 mm to 2 mm; or 0.1 mm to 1.5 mm; or 0.1 mm to 1 mm; or 0.1 mm to 0.5 mm; or 0.5 mm to 5 mm; or 0.5 mm to 4 mm; or 0.5 mm to 3 mm; or 0.5 mm to 2 mm; or 0.5 mm to 1 mm; or 1 mm to 5 mm; or 1 mm to 4 mm; or 1 mm to 3 mm; or 1 mm to 2 mm; or 2 mm to 5 mm; or 2 mm to 4 mm; or 2 mm to 3 mm; or 3 mm to 5 mm; or 3 mm to 4 mm; or 4 mm to 5 mm; or more than 0.1 mm; or less than 0.1 mm, such as 10 nm-100 nm; or 10 nm-1000 nm. One skilled in the art can identify preferred thicknesses and geometries of the spacer depending on the electrolyte density, the height of the hydraulic head to be discharged and/or the required fluid dynamic conditions.

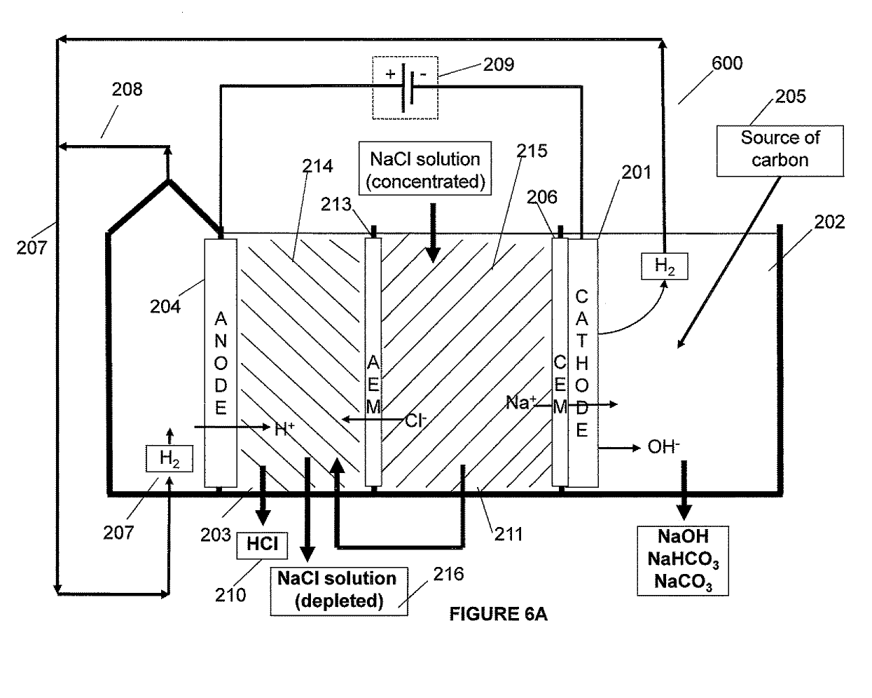

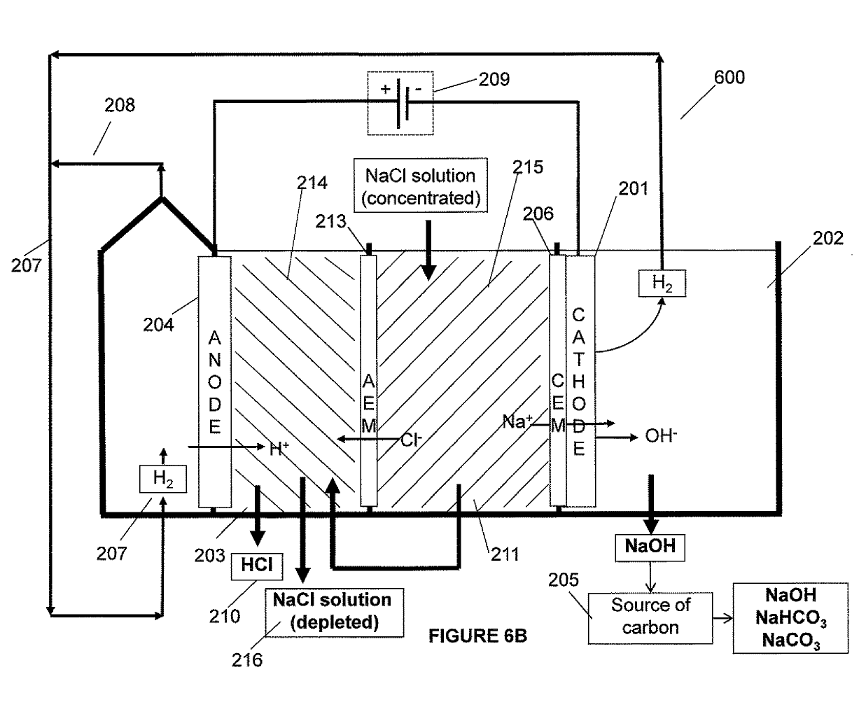

In some embodiments, the systems provided herein may include both the percolator and the spacer depending on the desired configuration of the electrochemical cell. An example of embodiments where both the percolator and the spacer are present, is illustrated in FIGS. 6A and 6B. It is to be understood that FIGS. 6A and 6B are for illustration purposes only and such percolator and/or spacer may be present in any of the electrochemical cells provided herein. Referring to FIGS. 6A and 6B, the system 600 in some embodiments includes a percolator 214 imposed between an anode 204 and the anion exchange membrane 213 such that the anode electrolyte 203 is disposed over the percolator 214. The system 600 in some embodiments also includes a spacer 215 imposed between the CEM 206 and AEM 213 such that the cathode electrolyte 202 is disposed over the spacer 215. The system 600 also includes a voltage 209 applied across the anode and the fine mesh cathode. In some embodiments, the anode may be a gas diffusion anode. In some embodiments, the anode may further include a second CEM. In some embodiments, the system includes a gas delivery system 207 configured to deliver hydrogen gas to the anode 204. In some embodiments, the hydrogen gas is obtained from the fine mesh cathode 201. In the system, the anode 204 is a gas diffusion anode configured to produce protons, and the fine mesh cathode 201 is configured to produce hydroxide ions and hydrogen gas when a voltage 209, e.g., less than 2V, is applied across the anode and the cathode. In the system, a gas is not produced at the anode 204.

In some embodiments, the system as illustrated in FIGS. 6A and 6B, is configurable to migrate anions, e.g., chloride ions, from the salt solution 211 inside the spacer 215 to the anode electrolyte 203 through the anion exchange membrane 213; migrate cations, e.g., sodium ions from the salt solution 211 inside the spacer 215 to the cathode electrolyte 202 through the first cation exchange membrane 206; migrate protons from the anode 204 to the anode electrolyte 203 inside the percolator; and migrate hydroxide ions from the cathode 201 to the cathode electrolyte 202. In some embodiments, the cathode 201 is the fine mesh cathode. In some embodiments, the cathode 201 is the fine mesh cathode supported on the coarse mesh cathode. In some embodiments, the cathode 201 is the fine mesh cathode and the coarse mesh cathode separated by a mattress such as a coil, spring, net, mesh or wire with undulations. In some embodiments, the mattress serves to support the fine mesh cathode and the coarse mesh cathode. In some embodiments, the system may be configured to contact the source of carbon with the cathode electrolyte inside the cathode chamber (FIG. 6A) or outside the cathode chamber (FIG. 6B). Thus, in some embodiments, the system may be configured to produce sodium hydroxide and/or sodium bicarbonate and/or sodium carbonate in the cathode electrolyte 202; and produce an acid e.g., hydrochloric acid 210 in the anode electrolyte 203.

In some embodiments for FIGS. 6A and 6B, on applying the voltage 209 across the anode and cathode, the system can be configured to produce hydroxide ions and hydrogen gas at the fine mesh cathode 201; migrate hydroxide ions from the cathode into the cathode electrolyte 202; migrate cations from the salt solution 211 in the spacer 215 to the cathode electrolyte 202 through the first cation exchange membrane 206; migrate chloride ions from the salt solution 211 in the spacer 215 to the anode electrolyte 203 through the anion exchange membrane 213; and migrate protons from the anode 204 to the anode electrolyte 203. Hence, depending on the salt solution 211 used, the system can be configured to produce an alkaline solution, e.g., sodium hydroxide in the cathode electrolyte. The first cation exchange membrane 206 may block the migration of anions from the cathode electrolyte 202 to the salt solution 211 in the spacer 215, causing the hydroxide ions to accumulate in the cathode electrolyte. The anion exchange membrane 213 may block the migration of cations, e.g., protons from the anode electrolyte 203 to the salt solution 211 in the spacer 215 causing the protons to accumulate in the anode electrolyte.

With reference to FIGS. 6A and 6B, the system in some embodiments may include a second cation exchange membrane 212 (not shown in FIGS. 6A and 6B), attached to the anode 204, such that it separates the anode 204 from the anode electrolyte 203 in the percolator 214. In this configuration, as the second cation exchange membrane 212 is permeable to cations, protons formed at the anode will migrate to the anode electrolyte as described herein; however, as the second cation exchange membrane 212 is impermeable to anions, e.g., chloride ions, in the anode electrolyte will be blocked from migrating to the anode 204, thereby avoiding interaction between the anode and the anions that may interact with the anode, e.g., by corrosion.

In the system as illustrated in FIGS. 6A and 6B, with the voltage across the anode and cathode, since the salt solution in the spacer 215 is separated from the cathode electrolyte by the first cation exchange membrane 206, cations in the salt solution, e.g., sodium ions, will migrate through the first cation exchange membrane 206 to the cathode electrolyte 202, and anions, e.g., chloride ions, will migrate to the anode electrolyte 203 through the anion exchange membrane 213. Consequently, in the system, as illustrated in FIGS. 6A and 6B, an acid, e.g., hydrochloric acid 210 is produced in the anode electrolyte 203, and alkaline solution, e.g., sodium hydroxide is produced in the cathode electrolyte 202. With the migration of cations and anions from the salt solution, the system in some embodiments can be configured to produce a partly or fully de-ionized salt solution from the salt solution 211. In some embodiments, this partially de-ionized salt solution can be used as feed-water to a desalination facility (not shown) where it can be further processed to produce desalinated water as described in commonly assigned U.S. Patent Application Publication no. US 2009/0001020, filed on Jun. 27, 2008, herein incorporated by reference in its entirety. In some embodiments, the solution can be used in industrial and agricultural applications where its salinity is acceptable. In some embodiments, as shown in FIGS. 6A and 6B, the partly de-ionized salt solution may be circulated to the anode electrolyte 203 which may then produce a partly or fully depleted or de-ionized salt solution for further processing, as described herein.

With reference to figures described herein, the system may be configured to direct hydrogen gas from the fine mesh cathode to the anode. It is to be understood that the systems where the hydrogen gas is not directed towards the anode are well within the scope of the invention. In some embodiments, the voltage across the anode and the cathode can be adjusted such that gas may form at the anode, e.g., oxygen or chlorine gas, while hydroxide ions and hydrogen gas is generated at the fine mesh cathode. In such embodiments, hydrogen gas is not supplied to the anode. However, in this embodiment, the voltage across the anode and the cathode may generally be higher compared to the embodiments where a gas does not form at the anode and the hydrogen gas is directed from the cathode to the anode. In some embodiments, the voltage across the anode and the cathode may generally be higher when the coarse mesh cathode is used, as compared to the lower voltage in some embodiments where the fine mesh cathode is used.

The systems provided herein include a hydrogen gas supply system configured to provide hydrogen gas to the anode. In some embodiments, the hydrogen may be obtained from the cathode including the fine mesh cathode and/or obtained from an external source, e.g., a commercial hydrogen gas supplier e.g., at start-up of operations when the hydrogen supply from the cathode is insufficient. In some embodiments, the hydrogen gas delivery system is configured to deliver gas to the anode where oxidation of the gas is catalyzed to protons and electrons. In some embodiments, the hydrogen gas is oxidized to protons and electrons; un-reacted hydrogen gas in the system is recovered and re-circulated to the anode (208 in the figures). The hydrogen delivery system includes any means for directing the hydrogen gas from the cathode or from the external source to the anode. Such means for directing the hydrogen gas from the cathode or from the external source to the anode are well known in the art and include, but not limited to, pipe, duct, conduit, and the like. In some embodiments, the system or the hydrogen delivery system includes a duct that directs the hydrogen gas from the cathode to the anode. It is to be understood that the hydrogen gas may be directed to the anode from the bottom of the cell, top of the cell or sideways. In some embodiments, the hydrogen gas may be directed to the anode through multiple entry ports.

On applying a voltage across the anode and the cathode, protons form at the anode from oxidation of hydrogen gas supplied to the anode, while hydroxide ions and hydrogen gas form at the fine mesh cathode from the reduction of water, as follows:

H₂=2H′+2e⁻ (anode, oxidation reaction)

2H₂O+2e⁻=H₂+2OH⁻ (cathode, reduction reaction)

Since protons are formed at the anode from hydrogen gas provided to the anode; and since a gas such as oxygen does not form at the anode; and since water in the cathode electrolyte forms hydroxide ions and hydrogen gas at the fine mesh cathode, the system can produce hydroxide ions in the cathode electrolyte and protons in the anode electrolyte when a voltage is applied across the anode and cathode. Further, in the systems provided herein, since a gas does not form at the anode, the system produces hydroxide ions in the cathode electrolyte and hydrogen gas at the fine mesh cathode and hydrogen ions at the anode when less than 3V is applied across the anode and cathode, in contrast to the higher voltage that is required when a gas is generated at the anode, e.g., chlorine or oxygen and/or in contrast to the higher voltage that is required when the coarse mesh cathode alone is used as the cathode. For example, in some embodiments, hydroxide ions, bicarbonate ions and/or carbonate ion are produced in the cathode electrolyte when a voltage of 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or 0.05V or less, or between 0.05V-4V, or between 0.05V-3V, or between 0.05V-2.5V, or between 0.05V-2V, or between 0.05V-1.5V, or between 0.05V-1V, or between 0.05V-0.5V, or between 0.05V-0.1V, or between 0.1V-3V, or between 0.1V-2.5V, or between 0.1V-2V, or between 0.1V-1.5V, or between 0.1V-1V, or between 0.1V-0.5V, or between 0.5V-3V, or between 0.5V-2.5V, or between 0.5V-2V, or between 0.5V-1.5V, or between 0.5V-1V, or between 1V-3V, or between 1V-2.5V, or between 1V-2V, or between 1V-1.5V, or between 1.5V-3V, or between 1.5V-2.5V, or between 1.5V-2V, or between 2V-3V, or between 2V-2.5V, or 0.05V, or 0.1V, or 0.5V, or 1V, or 2V, or 3V, is applied across the anode and the fine mesh cathode.

In another embodiment, the voltage across the anode and the cathode can be adjusted such that gas is formed at the anode, e.g., oxygen or chlorine, while hydroxide ions, carbonate ions and/or bicarbonate ions are produced in the cathode electrolyte and hydrogen gas is generated at the fine mesh cathode. However, in this embodiment, hydrogen gas is not supplied to the anode. As can be appreciated by one ordinarily skilled in the art, in this embodiment, the voltage or the primary voltage across the anode and the cathode will be generally higher compared to the embodiment when a gas does not form at the anode.

In some embodiments, the carbon from the source of carbon, when contacted with the cathode electrolyte inside the cathode chamber, reacts with the hydroxide ions and produces water and carbonate ions, depending on the pH of the cathode electrolyte. The addition of the carbon from the source of carbon to the cathode electrolyte may lower the pH of the cathode electrolyte. Thus, depending on the degree of alkalinity desired in the cathode electrolyte, the pH of the cathode electrolyte may be adjusted and in some embodiments is maintained between and 7 and 14 or greater; or between 7 and 13; or between 7 and 12; or between 7 and 11; or between 7 and 10; or between 7 and 9; or between 7 and 8; or between 8 and 14 or greater; or between 8 and 13; or between 8 and 12; or between 8 and 11; or between 8 and 10; or between 8 and 9; or between 9 and 14 or greater; or between 9 and 13; or between 9 and 12; or between 9 and 11; or between 9 and 10; or between 10 and 14 or greater; or between 10 and 13; or between 10 and 12; or between 10 and 11; or between 11 and 14 or greater; or between 11 and 13; or between 11 and 12; or between 12 and 14 or greater; or between 12 and 13; or between 13 and 14 or greater. In some embodiments, the pH of the cathode electrolyte may be adjusted to any value between 7 and 14 or greater, including a pH 7.0, 7.5, 8.0, 8.5. 9.0, 9.5, 10.0, 10.5, 11.0, 11.5, 12.0, 12.5, 13.0, 13.5, 14.0, and/or greater.

Similarly, in some embodiments of the system, the pH of the anode electrolyte is adjusted and is maintained between 0-7; or between 0-6; or between 0-5; or between 0-4; or between 0-3; or between 0-2; or between 0-1, by regulating the concentration of hydrogen ions that migrate into the anode electrolyte from oxidation of hydrogen gas at the anode, and/or the withdrawal and replenishment of anode electrolyte in the system. As the voltage across the anode and cathode may be dependent on several factors including the difference in pH between the anode electrolyte and the cathode electrolyte (as can be determined by the Nernst equation well known in the art), in some embodiments, the pH of the anode electrolyte may be adjusted to a value between 0 and 7, including 0, 0.5, 1.0, 1.5, 2.0, 2.5, 3.0, 3.5, 4.0, 4.5, 5.0, 5.5, 6.0, 6.5 and 7, depending on the desired operating voltage across the anode and cathode. Thus, as can be appreciated, in equivalent systems, where it is desired to reduce the energy used and/or the voltage across the anode and cathode, e.g., as in the chloralkali process, the carbon from the source of carbon can be added to the cathode electrolyte as disclosed herein to achieve a desired pH difference between the anode electrolyte and cathode electrolyte. Thus, to the extent that such systems utilize the source of carbon, these equivalent systems are within the scope of the present invention.

The system may be configured to produce any desired pH difference between the anode electrolyte and the cathode electrolyte by modulating the pH of the anode electrolyte, the pH of the cathode electrolyte, the concentration of sodium hydroxide in the cathode electrolyte, the concentration of hydrochloric acid in the anode electrolyte, the amount of hydrogen gas from the cathode to the anode, the withdrawal and replenishment of the anode electrolyte, the withdrawal and replenishment of the cathode electrolyte, and/or the amount of the carbon from the source of carbon added to the cathode electrolyte. By modulating the pH difference between the anode electrolyte and the cathode electrolyte, the operating voltage across the anode and the cathode can be modulated. In some embodiments, the system is configured to produce a pH difference of at least 4 pH units; at least 5 pH units; at least 6 pH units; at least 7 pH units; at least 8 pH units; at least 9 pH units; at least 10 pH units; at least 11 pH units; at least 12 pH units; at least 13 pH units; at least 14 pH units; or between 4-12 pH units; or between 4-11 pH units; or between 4-10 pH units; or between 4-9 pH units; or between 4-8 pH units; or between 4-7 pH units; or between 4-6 pH units; or between 4-5 pH units; or between 3-12 pH units; or between 3-11 pH units; or between 3-10 pH units; or between 3-9 pH units; or between 3-8 pH units; or between 3-7 pH units; or between 3-6 pH units; or between 3-5 pH units; or between 3-4 pH units; or between 5-12 pH units; or between 5-11 pH units; or between 5-10 pH units; or between 5-9 pH units; or between 5-8 pH units; or between 5-7 pH units; or between 5-6 pH units; or between 7-12 pH units; or between 7-11 pH units; or between 7-10 pH units; or between 7-9 pH units; or between 7-8 pH units; or between 8-12 pH units; or between 8-11 pH units; or between 8-10 pH units; or between 8-9 pH units; or between 9-12 pH units; or between 9-11 pH units; or between 9-10 pH units; or between 10-12 pH units; or between 10-11 pH units; or between 11-12 pH units; between the anode electrolyte and the cathode electrolyte. In some embodiments, the system is configured to produce a pH difference of at least 4 pH units between the anode electrolyte and the cathode electrolyte.

In some embodiments, the system is configured to produce the above recited pH difference between the anode electrolyte and the cathode electrolyte when a voltage with a voltage of 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or 0.05V or less, or between 0.05V-4V, or between 0.05V-3V, or between 0.05V-2.5V, or between 0.05V-2V, or between 0.05V-1.5V, or between 0.05V-1V, or between 0.05V-0.5V, or between 0.05V-0.1V, or between 0.1V-3V, or between 0.1V-2.5V, or between 0.1V-2V, or between 0.1V-1.5V, or between 0.1V-1V, or between 0.1V-0.5V, or between 0.1V-0.05V, or between 0.5V-3V, or between 0.5V-2.5V, or between 0.5V-2V, or between 0.5V-1.5V, or between 0.5V-1V, or between 1V-3V, or between 1V-2.5V, or between 1V-2V, or between 1V-1.5V, or between 2V-3V, or between 2V-2.5V, or 0.05V, or 0.1V, or 0.5V, or 1V, or 2V, or 3V, is applied between the anode and the fine mesh cathode.

In some embodiments, the cathode electrolyte and/or the anode electrolyte in the systems and methods provided herein include, but are not limited to, saltwater or fresh water. The saltwater includes, but is not limited to, seawater, brine, and/or brackish water. In some embodiments, the cathode electrolyte in the systems and methods provided herein include, but are not limited to, seawater, freshwater, brine, brackish water, sodium hydroxide, or combination thereof. “Saltwater” is employed in its conventional sense to refer to a number of different types of aqueous fluids other than fresh water, where the term “saltwater” includes, but is not limited to, brackish water, sea water and brine (including, naturally occurring subterranean brines or anthropogenic subterranean brines and man-made brines, e.g., geothermal plant wastewaters, desalination waste waters, etc), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source may be a naturally occurring source, such as a sea, ocean, lake, swamp, estuary, lagoon, etc., or a man-made source. In some embodiments, the cathode electrolyte and/or the anode electrolyte, such as, saltwater includes water containing more than 1% chloride content, such as, NaCl; or more than 10% NaCl; or more than 20% NaCl; or more than 30% NaCl; or more than 40% NaCl; or more than 50% NaCl; or more than 60% NaCl; or more than 70% NaCl; or more than 80% NaCl; or more than 90% NaCl; or between 1-99% NaCl; or between 1-95% NaCl; or between 1-90% NaCl; or between 1-80% NaCl; or between 1-70% NaCl; or between 1-60% NaCl; or between 1-50% NaCl; or between 1-40% NaCl; or between 1-30% NaCl; or between 1-20% NaCl; or between 1-10% NaCl; or between 10-99% NaCl; or between 10-95% NaCl; or between 10-90% NaCl; or between 10-80% NaCl; or between 10-70% NaCl; or between 10-60% NaCl; or between 10-50% NaCl; or between 10-40% NaCl; or between 10-30% NaCl; or between 10-20% NaCl; or between 20-99% NaCl; or between 20-95% NaCl; or between 20-90% NaCl; or between 20-80% NaCl; or between 20-70% NaCl; or between 20-60% NaCl; or between 20-50% NaCl; or between 20-40% NaCl; or between 20-30% NaCl; or between 30-99% NaCl; or between 30-95% NaCl; or between 30-90% NaCl; or between 30-80% NaCl; or between 30-70% NaCl; or between 30-60% NaCl; or between 30-50% NaCl; or between 30-40% NaCl; or between 40-99% NaCl; or between 40-95% NaCl; or between 40-90% NaCl; or between 40-80% NaCl; or between 40-70% NaCl; or between 40-60% NaCl; or between 40-50% NaCl; or between 50-99% NaCl; or between 50-95% NaCl; or between 50-90% NaCl; or between 50-80% NaCl; or between 50-70% NaCl; or between 50-60% NaCl; or between 60-99% NaCl; or between 60-95% NaCl; or between 60-90% NaCl; or between 60-80% NaCl; or between 60-70% NaCl; or between 70-99% NaCl; or between 70-95% NaCl; or between 70-90% NaCl; or between 70-80% NaCl; or between 80-99% NaCl; or between 80-95% NaCl; or between 80-90% NaCl; or between 90-99% NaCl; or between 90-95% NaCl.

In some embodiments, the cathode electrolyte and/or the anode electrolyte includes water containing more than 1% sulfate content or between 1-100% sulfate, such as, sodium sulfate, potassium sulfate, and the like; or more than 10% sulfate; or more than 20% sulfate; or more than 30% sulfate; or more than 40% sulfate; or more than 50% sulfate; or more than 60% sulfate; or more than 70% sulfate; or more than 80% sulfate; or more than 90% sulfate; or between 1-99% sulfate; or between 1-95% sulfate; or between 1-90% sulfate; or between 1-80% sulfate; or between 1-70% sulfate; or between 1-60% sulfate; or between 1-50% sulfate; or between 1-40% sulfate; or between 1-30% sulfate; or between 1-20% sulfate; or between 1-10% sulfate; or between 10-99% sulfate; or between 10-95% sulfate; or between 10-90% sulfate; or between 10-80% sulfate; or between 10-70% sulfate; or between 10-60% sulfate; or between 10-50% sulfate; or between 10-40% sulfate; or between 10-30% sulfate; or between 10-20% sulfate; or between 20-99% sulfate; or between 20-95% sulfate; or between 20-90% sulfate; or between 20-80% sulfate; or between 20-70% sulfate; or between 20-60% sulfate; or between 20-50% sulfate; or between 20-40% sulfate; or between 20-30% sulfate; or between 30-99% sulfate; or between 30-95% sulfate; or between 30-90% sulfate; or between 30-80% sulfate; or between 30-70% sulfate; or between 30-60% sulfate; or between 30-50% sulfate; or between 30-40% sulfate; or between 40-99% sulfate; or between 40-95% sulfate; or between 40-90% sulfate; or between 40-80% sulfate; or between 40-70% sulfate; or between 40-60% sulfate; or between 40-50% sulfate; or between 50-99% sulfate; or between 50-95% sulfate; or between 50-90% sulfate; or between 50-80% sulfate; or between 50-70% sulfate; or between 50-60% sulfate; or between 60-99% sulfate; or between 60-95% sulfate; or between 60-90% sulfate; or between 60-80% sulfate; or between 60-70% sulfate; or between 70-99% sulfate; or between 70-95% sulfate; or between 70-90% sulfate; or between 70-80% sulfate; or between 80-99% sulfate; or between 80-95% sulfate; or between 80-90% sulfate; or between 90-99% sulfate; or between 90-95% sulfate.

In some embodiments, the cathode electrolyte, such as, saltwater, fresh water, and/or sodium hydroxide do not include divalent cations. As used herein, the divalent cations include alkaline earth metal ions, such as but not limited to, calcium, magnesium, barium, strontium, radium, etc. In some embodiments, the cathode electrolyte, such as, saltwater, fresh water, and/or sodium hydroxide include less than 1% w/w divalent cations. Examples of salt water include, but not limited to, seawater, freshwater including sodium chloride, brine, or brackish water. In some embodiments, the cathode electrolyte, such as, seawater, freshwater, brine, brackish water, and/or sodium hydroxide include less than 1% w/w divalent cations. In some embodiments, the cathode electrolyte, such as, seawater, freshwater, brine, brackish water, and/or sodium hydroxide include divalent cations including, but not limited to, calcium, magnesium, and combination thereof. In some embodiments, the cathode electrolyte, such as, seawater, freshwater, brine, brackish water, and/or sodium hydroxide include less than 1% w/w divalent cations including, but not limited to, calcium, magnesium, and combination thereof. In some embodiments, the cathode electrolyte, such as, seawater, freshwater, brine, brackish water, and/or sodium hydroxide include less than 1% w/w; or less than 5% w/w; or less than 10% w/w; or less than 15% w/w; or less than 20% w/w; or less than 25% w/w; or less than 30% w/w; or less than 40% w/w; or less than 50% w/w; or less than 60% w/w; or less than 70% w/w; or less than 80% w/w; or less than 90% w/w; or less than 95% w/w; or between 0.05-1% w/w; or between 0.5-1% w/w; or between 0.5-5% w/w; or between 0.5-10% w/w; or between 0.5-20% w/w; or between 0.5-30% w/w; or between 0.5-40% w/w; or between 0.5-50% w/w; or between 0.5-60% w/w; or between 0.5-70% w/w; or between 0.5-80% w/w; or between 0.5-90% w/w; or between 5-8% w/w; or between 5-10% w/w; or between 5-20% w/w; or between 5-30% w/w; or between 5-40% w/w; or between 5-50% w/w; or between 5-60% w/w; or between 5-70% w/w; or between 5-80% w/w; or between 5-90% w/w; or between 10-20% w/w; or between 10-30% w/w; or between 10-40% w/w; or between 10-50% w/w; or between 10-60% w/w; or between 10-70% w/w; or between 10-80% w/w; or between 10-90% w/w; or between 30-40% w/w; or between 30-50% w/w; or between 30-60% w/w; or between 30-70% w/w; or between 30-80% w/w; or between 30-90% w/w; or between 50-60% w/w; or between 50-70% w/w; or between 50-80% w/w; or between 50-90% w/w; or between 75-80% w/w; or between 75-90% w/w; or between 80-90% w/w; or between 90-95% w/w; of divalent cations including, but not limited to, calcium, magnesium, and combination thereof.

In some embodiments, the cathode electrolyte includes, but not limited to, sodium hydroxide, sodium bicarbonate, sodium carbonate, or combination thereof. In some embodiments, the cathode electrolyte includes, but not limited to, sodium hydroxide. In some embodiments, the cathode electrolyte includes, but not limited to, sodium hydroxide, divalent cations, or combination thereof. In some embodiments, the cathode electrolyte includes, but not limited to, sodium hydroxide, sodium bicarbonate, sodium carbonate, divalent cations, or combination thereof. In some embodiments, the cathode electrolyte includes, but not limited to, sodium hydroxide, calcium bicarbonate, calcium carbonate, magnesium bicarbonate, magnesium carbonate, calcium magnesium carbonate, or combination thereof. In some embodiments, the cathode electrolyte includes, but not limited to, saltwater, sodium hydroxide, bicarbonate brine solution, or combination thereof. In some embodiments, the cathode electrolyte includes, but not limited to, saltwater and sodium hydroxide. In some embodiments, the cathode electrolyte includes, but not limited to, fresh water and sodium hydroxide. In some embodiments, the cathode electrolyte includes, but not limited to, fresh water, sodium hydroxide, sodium bicarbonate, sodium carbonate, divalent cations, or combination thereof.

In some embodiments, the anode electrolyte includes, but not limited to, fresh water and hydrochloric acid. In some embodiments, the anode electrolyte includes, but not limited to, saltwater and hydrochloric acid. In some embodiments, the anode electrolyte includes hydrochloric acid.

As is illustrated in FIGS. 2A, 2B, 3A, and 3B, in some embodiments, the anode electrolyte includes saltwater solution and hydrochloric acid and the cathode electrolyte includes hydroxide solution. As is illustrated in FIGS. 4A and 4B, in some embodiments, the cathode electrolyte includes saltwater solution and hydroxide and the anode electrolyte includes hydrochloric acid solution. As is illustrated in FIGS. 5A, 5B, 6A, and 6B, in some embodiments, the cathode electrolyte includes hydroxide and the anode electrolyte includes hydrochloric acid. In some embodiments, the depleted saltwater from the cell may be circulated back to the anode electrolyte. In some embodiments, the cathode electrolyte includes 1-90%; 1-50%; or 1-40%; or 1-30%; or 1-15%; or 1-20%; or 1-10%; or 5-90%; or 5-50%; or 5-40%; or 5-30%; or 5-20%; or 5-10%; or 10-90%; or 10-50%; or 10-40%; or 10-30%; or 10-20%; or 15-20%; or 15-30%; or 20-30%, of the sodium hydroxide solution. In some embodiments, the anode electrolyte includes 0-5M hydrochloric acid solution; or 0-4.5M; or 0-4M; or 0-3.5M; or 0-3M; or 0-2.5M; or 0-2M; or 0-1.5M; or 0-1M; or 1-5M; or 1-4.5M; or 1-4M; or 1-3.5M; or 1-3M; or 1-2.5M; or 1-2M; or 1-1.5M; or 2-5M; or 2-4.5M; or 2-4M; or 2-3.5M; or 2-3M; or 2-2.5M; or 3-5M; or 3-4.5M; or 3-4M; or 3-3.5M; or 4-5M; or 4.5-5M. In some embodiments, the anode does not form an oxygen gas. In some embodiments, the anode does not form a chlorine gas.

In some embodiments, the cathode electrolyte does not include carbon dioxide gas. In some embodiments, no carbon dioxide is dissolved into the cathode electrolyte of the electrochemical cell. In some embodiments, the source of carbon is carbon dioxide which is dissolved into the cathode electrolyte of the electrochemical cell. Although carbon dioxide may be present in ordinary ambient air, in view of its very low concentration, ambient carbon dioxide will not provide sufficient carbon dioxide to achieve the formation of the bicarbonate and/or carbonate in the cathode electrolyte as is obtained when carbon from the source of carbon is contacted with the cathode electrolyte inside the cathode chamber. In some embodiments of the system and method, the pressure inside the electrochemical system may be greater than the ambient atmospheric pressure in the ambient air and hence ambient carbon dioxide may typically be prevented from infiltrating into the cathode electrolyte.

In some embodiments, the systems provided herein are configured to produce hydroxide ions at the cathode without forming a gas at the anode on applying a voltage across the anode and the cathode including the fine mesh cathode. In some embodiments, the systems are configured to produce hydroxide ions in the cathode electrolyte and hydrochloric acid in the anode electrolyte on applying a voltage across the anode and the cathode including the fine mesh cathode.

In some embodiments, the cathode electrolyte and the anode electrolyte are separated in part or in full by an ion exchange membrane. In some embodiments, the ion exchange membrane is an anion exchange membrane or a cation exchange membrane. In some embodiments, the cation exchange membranes in the electrochemical cell, as disclosed herein, are conventional and are available from, for example, Asahi Kasei of Tokyo, Japan; or from Membrane International of Glen Rock, N.J., or DuPont, in the USA. Examples of cationic exchange membranes include, but not limited to, cationic membrane consisting of a perfluorinated polymer containing anionic groups, for example sulphonic and/or carboxylic groups. However, it may be appreciated that in some embodiments, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of sodium ions into the cathode electrolyte from the anode electrolyte while restricting migration of hydrogen ions from the anode electrolyte into the cathode electrolyte, may be used. Similarly, it may be appreciated that in some embodiments, depending on the need to restrict or allow migration of a specific anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte from the cathode electrolyte while restricting migration of hydroxide ions from the cathode electrolyte into the anode electrolyte, may be used. Such restrictive cation and/or anion exchange membranes are commercially available and can be selected by one ordinarily skilled in the art.

In some embodiments, there is provided a system comprising one or more anion exchange membrane, and cation exchange membranes located between the anode and the cathode including the fine mesh cathode. In some embodiments, the membranes should be selected such that they can function in an acidic and/or basic electrolytic solution as appropriate. Other desirable characteristics of the membranes include high ion selectivity, low ionic resistance, high burst strength, and high stability in an acidic electrolytic solution in a temperature range of 0° C. to 100° C. or higher, or a alkaline solution in similar temperature range may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., or 0° C. to 30° C., or 0° C. to 20° C., or 0° C. to 10° C., or higher may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., but unstable at higher temperature, may be used. For other embodiments, it may be useful to utilize an ion-specific ion exchange membranes that allows migration of one type of cation but not another; or migration of one type of anion and not another, to achieve a desired product or products in an electrolyte. In some embodiments, the membrane may be stable and functional for a desirable length of time in the system, e.g., several days, weeks or months or years at temperatures in the range of 0° C. to 90° C.; or 0° C. to 80° C.; or 0° C. to 70° C.; or 0° C. to 60° C.; or 0° C. to 50° C.; or 0° C. to 40° C.; or 0° C. to 30° C.; or 0° C. to 20° C.; or 0° C. to 10° C., and higher and/or lower. In some embodiments, for example, the membranes may be stable and functional for at least 1 day, at least 5 days, 10 days, 15 days, 20 days, 100 days, 1000 days, 5-10 years, or more in electrolyte temperatures at 100° C., 90° C., 80° C., 70° C., 60° C., 50° C., 40° C., 30° C., 20° C., 10° C., 5° C. and more or less.

The ohmic resistance of the membranes may affect the voltage drop across the anode and cathode, e.g., as the ohmic resistance of the membranes increase, the voltage across the anode and cathode may increase, and vice versa. Membranes that can be used include, but are not limited to, membranes with relatively low ohmic resistance and relatively high ionic mobility; and membranes with relatively high hydration characteristics that increase with temperatures, and thus decreasing the ohmic resistance. By selecting currently available membranes with lower ohmic resistance, the voltage drop across the anode and cathode at a specified temperature can be lowered.

Scattered through currently available membranes may be ionic channels including acid groups. These ionic channels may extend from the internal surface of the matrix to the external surface and the acid groups may readily bind water in a reversible reaction as water-of-hydration. This binding of water as water-of-hydration may follow first order reaction kinetics, such that the rate of reaction is proportional to temperature. Consequently, currently available membranes can be selected to provide a relatively low ohmic and ionic resistance while providing for improved strength and resistance in the system for a range of operating temperatures.

In some embodiments, the anode in the electrochemical cell is configured to oxidize hydrogen gas (a hydrogen oxidizing anode) to produce hydrogen ions. By way of example only, the systems provided herein may comprise a gas diffusion anode. In some embodiments, the anode and the second cation exchange membrane may include an integral gas diffusion anode that is commercially available, or can be fabricated as described for example in co-pending and commonly assigned International Patent Application Publication no. WO 2010/093716, titled “Low-voltage alkaline production using hydrogen and electrocatalytic electrodes”, filed Feb. 10, 2010, herein fully incorporated by reference. It is to be understood that the gas diffusion anode is illustrated as an example only and any conventional anode that can be configured to oxidize hydrogen gas (a hydrogen oxidizing anode) to produce hydrogen, can be utilized.

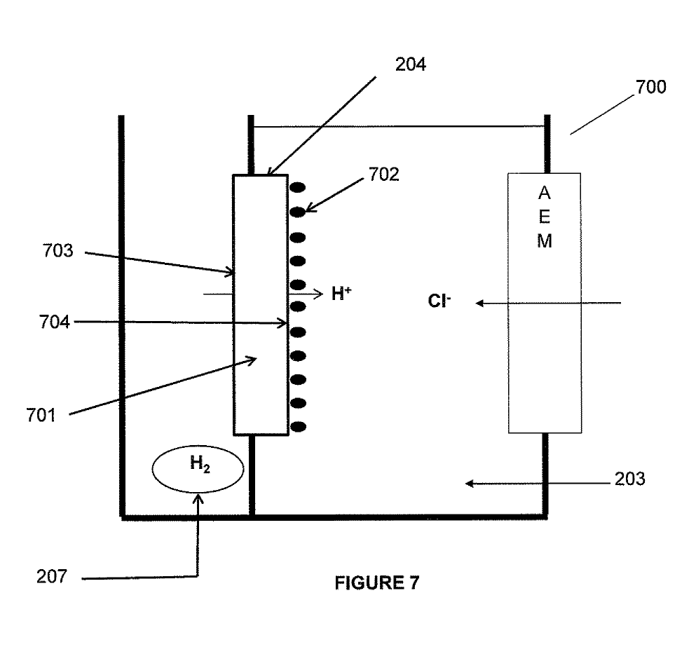

FIG. 7 illustrates a schematic of a gas diffusion anode 700 that can be used in the systems described herein. In some embodiments, the gas diffusion anode 700 comprises a conductive substrate 701 infused with a catalyst 702 that is capable of catalyzing the oxidation of hydrogen gas to protons when the voltage is applied across the anode and cathode. In some embodiments, the anode comprises a first side 703 that interfaces with hydrogen gas provided to the anode, and an opposed second side 704 that interfaces with the anode electrolyte 203. In some embodiments, the portion of the substrate 703 that interfaces with the hydrogen gas is hydrophobic and is relatively dry; and the portion of the substrate 704 that interfaces with the anode electrolyte 203 is hydrophilic and may be wet, which may facilitate migration of protons from the anode to the anode electrolyte. In some embodiments, the substrate is porous to facilitate the movement of gas from the first side 703 to the catalyst 702 that may be located on second side 704 of the anode; in some embodiments, the catalyst may also be located within the body of the substrate 701. The substrate 701 may be selected for its hydrophilic or hydrophobic characteristics as described herein, and also for its low ohmic resistance to facilitate electron conduction from the anode through a current collector connected to the voltage supply 209; the substrate may also be selected for it porosity to ion migration, e.g., proton migration, from the anode to the anode electrolyte. In some embodiments, the catalyst 702 may include metals including, but not limited to, platinum, ruthenium, iridium, rhodium, manganese, silver, or alloys thereof, or mixture thereof. Suitable gas diffusion anodes are available commercially, e.g., from E-TEK (USA) and other suppliers.

In some embodiments, e.g. as illustrated in FIGS. 3A and 3B, the anode may be a gas diffusion anode including an ion exchange membrane, e.g., a cation exchange membrane 212 that contacts the second side 604 of the anode. In such embodiments, the ion exchange membrane can be used to allow or prevent migration of ions to or from the anode. Thus, for example, with reference to FIG. 3A, when protons are generated at the anode, a cation exchange membrane may be used to facilitate the migration of the protons from the anode and/or block the migration of ions, e.g., cations to the substrate. In some embodiments, the ion exchange membrane may be selected to preferentially allow passage of one type of cation, e.g., hydrogen ions, while preventing the passage of another type of ions, e.g., sodium ions.

In some embodiments, the systems provided herein include the saltwater from terrestrial brine. In some embodiments, the depleted saltwater withdrawn from the electrochemical cells is replenished with sodium chloride and re-circulated back in the electrochemical cell.

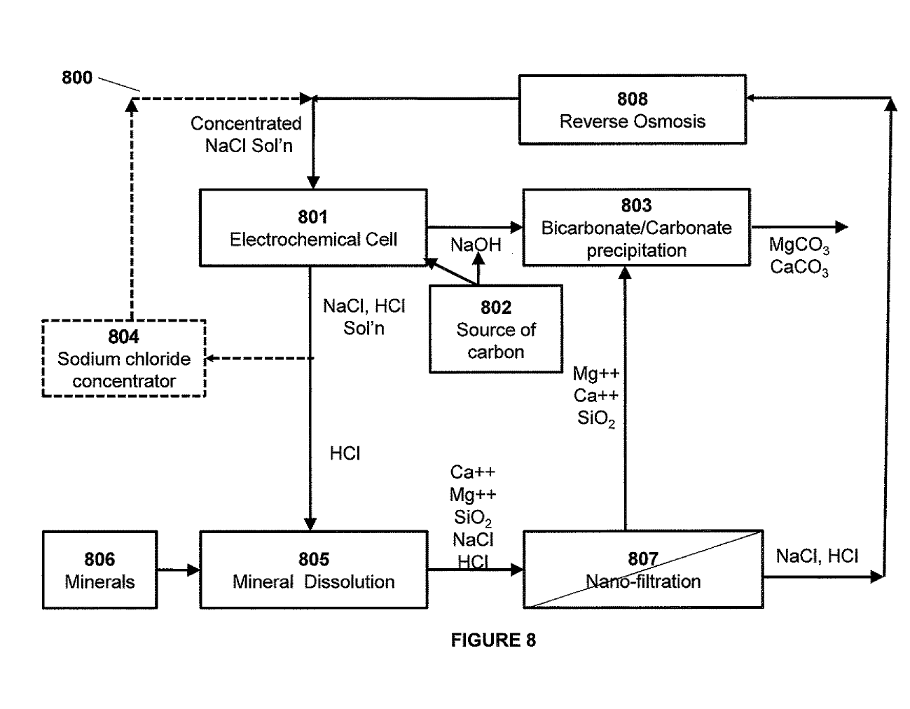

FIG. 8 illustrates an overall flow diagram 800 for some embodiments where the electrochemical cell is integrated with other processes to produce carbonate compositions and recycle the spent solutions. In some embodiments, the alkaline solution produced by the electrochemical cell 801 may be contacted with the source of carbon 802 inside the cathode chamber and/or outside the cathode chamber to produce a bicarbonate/carbonate ion solution. As used herein, the “source of carbon” includes any source of carbon that when treated with hydroxide results in bicarbonate and/or carbonate ion formation. The source of carbon includes, but not limited, to gaseous stream of CO₂; solution containing dissolved form of CO₂ including carbonic acid; and/or bicarbonate brine solution. The bicarbonate/carbonate ion solution or substantially carbonate ion solution 803 formed from the treatment of the carbon from the source of carbon with the hydroxide from the cathode electrolyte, may be then treated with the divalent cations, e.g., calcium, magnesium, or combination thereof, to precipitate the bicarbonate and/or carbonate, e.g., calcium carbonate, magnesium carbonate, calcium bicarbonate, magnesium bicarbonate, calcium magnesium carbonate, or combination thereof. The calcium carbonate, magnesium carbonate, calcium bicarbonate, magnesium bicarbonate, calcium magnesium carbonate, or combination thereof may form cementitous compositions. The sodium chloride solution produced by the electrochemical cell 801 may optionally be concentrated in the sodium chloride concentrator 804 before being injected back into the electrochemical cell 801. The sodium chloride may be separated from hydrochloric acid after being removed from the electrochemical cell. The hydrochloric acid produced by the electrochemical cell 801 may be subjected to a mineral dissolution system 805 which may be configured to dissolve minerals 806, such as mafic and/or ultramafic minerals, e.g., serpentine, olivine, etc. and produce a mineral solution comprising divalent cations, e.g., calcium and/or magnesium and/or silica, etc. The mineral solution may then be filtered via nano filtration system 807 to separate the divalent cations, such as calcium, magnesium, silica, etc. from sodium chloride and HCl. The divalent cations may then be treated with the bicarbonate/carbonate solution 803 to form carbonate compositions, such as, calcium carbonate, magnesium carbonate, calcium bicarbonate, magnesium bicarbonate, calcium magnesium carbonate, or combination thereof. The filtrate containing the sodium chloride and/or HCl may then be subjected to reverse osmosis system 808 to concentrate the sodium chloride solution before injecting it back into the electrochemical cell 801. The various components of the flow diagram illustrated in FIG. 8, are described in detail below. It is to be understood that FIG. 8 is for illustration purposes only and does not in any way limit the scope of the invention. Some of the steps of FIG. 8 may be omitted, modified, or rearranged in order, for the methods and systems provided herein.

In some embodiments of the electrochemical cells described herein, the system is configured to produce carbonate ions by a reaction of the carbon such as, CO₂, carbonic acid, bicarbonate ions, carbonate ions, or combination thereof, from the source of carbon with sodium hydroxide from the cathode electrolyte. The source of carbon may be a gaseous stream of CO₂. This gaseous CO₂ is, in certain instances, a waste stream or product from an industrial plant. The nature of the industrial plant may vary in these embodiments, where industrial plants of interest includes, but is not limited to, power plants (e.g., as described in further detail in International Application No. PCT/US08/88318, titled, “Methods of sequestering CO₂,” filed 24 Dec. 2008, the disclosure of which is herein incorporated by reference), chemical processing plants, steel mills, paper mills, cement plants (e.g., as described in further detail in U.S. Provisional Application Ser. No. 61/088,340, the disclosure of which is herein incorporated by reference), and other industrial plants that produce CO₂ as a byproduct. By waste stream is meant a stream of gas (or analogous stream) that is produced as a byproduct of an active process of the industrial plant. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Exhaust gases containing NOx, SOx, VOCs, particulates and Hg would incorporate these compounds along with the carbonate in the precipitated product. Particular multi-component gaseous streams of interest that may be treated according to the subject invention include, but not limited to, oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

Thus, the waste streams may be produced from a variety of different types of industrial plants. Suitable waste streams for the invention include waste streams, such as, flue gas, produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

The contact of the source of carbon, such as, a gaseous stream of CO₂ with the cathode electrolyte is as described in U.S. Publication No. 2010/0084280, filed Nov. 12, 2009, which is incorporated herein by reference in its entirety.

In some embodiments, the source of carbon may be a solution with dissolved form of CO₂. The dissolved form of CO₂, includes, but is not limited to, carbonic acid, bicarbonate ions, carbonate ions, or combination thereof. In some embodiments, the solution charged with the partially or fully dissolved CO₂ is made by parging or diffusing the CO₂ gaseous stream through a solution to make a CO₂ charged water. In some embodiments, the solution with CO₂ includes a proton removing agent. In some embodiments, the CO₂ gas is bubbled or parged through a solution containing a proton removing agent, such as sodium or potassium hydroxide, in an absorber. In some embodiments, the absorber may include a bubble chamber where the CO₂ gas is bubbled through the solution containing the proton removing agent. In some embodiments, the absorber may include a spray tower where the solution containing the proton removing agent is sprayed or circulated through the CO₂ gas. In some embodiments, the absorber may include a pack bed to increase the surface area of contact between the CO₂ gas and the solution containing the proton removing agent. In some embodiments, a typical absorber fluid temperature is 32-37° C. The absorber for absorbing CO₂ in the solution is described in U.S. application Ser. No. 12/721,549, filed on Mar. 10, 2010, which is incorporated herein by reference in its entirety.

In some embodiments, the source of carbon is the bicarbonate brine solution. In some embodiments, the systems and methods provided herein include systems and methods configured to produce the carbon from the source of carbon, such as, bicarbonate brine solution. The bicarbonate brine solution, is as described in U.S. Provisional Application No. 61/433,641, filed on Jan. 18, 2011 and U.S. Provisional Application No. 61/408,325, filed Oct. 29, 2010, which are both incorporated herein by reference in their entirety. As used herein, the “bicarbonate brine solution” includes any brine containing bicarbonate. In some embodiments, the brine is a synthetic brine such as a solution of brine containing the bicarbonate, e.g., sodium bicarbonate, potassium bicarbonate, lithium bicarbonate etc. In some embodiments, the brine is a naturally occurring bicarbonate brine, e.g., subterranean brine such as naturally occurring lakes. The bicarbonate brine can be made from subterranean brines, such as but not limited to, carbonate brines, alkaline brines, hard brines, and/or alkaline hard brines. The bicarbonate brine can also be made from minerals where the minerals may be crushed and dissolved in brine and optionally further processed. The minerals can be found under the surface, on the surface, or subsurface of the lakes. The bicarbonate brine can also be made from evaporite. The bicarbonate brine may include other oxyanions of carbon in addition to bicarbonate (HCO₃⁻), such as, but not limited to, carbonic acid (H₂CO₃) and/or carbonate (CO₃²).

For example, with reference to the system illustrated in FIGS. 2A, 2B, 3A, 3B, 4A, 4B, 5A, 5B, 6A, and/or 6B, in some embodiments, the system is further configured to produce the bicarbonate brine solution. After the production of the bicarbonate brine by the methods and systems described herein, the bicarbonate brine solution may be contacted with the cathode electrolyte inside the cathode chamber and/or outside the cathode chamber, as described herein. In some embodiments, the cathode electrolyte may be operatively connected to a reactor system configured to produce the bicarbonate brine solution. The systems and methods to produce the bicarbonate brine solution, to optionally modify the bicarbonate brine solution and/or to store the brine, are described in detail in U.S. Provisional Application No. 61/433,641, filed on Jan. 18, 2011, which is incorporated herein by reference in its entirety. In some embodiments of the method, the method further includes treating the bicarbonate ions and/or carbonate ions with the divalent cations to produce carbonate compositions. These methods have been described in detail herein.

The contacting of the carbon from the source of carbon to the cathode electrolyte may be outside the cathode chamber and/or inside the cathode chamber. In some embodiments, the carbon from the source of carbon may be contacted with the cathode electrolyte inside the cathode chamber and after withdrawing or recovering the cathode electrolyte containing hydroxide and/or bicarbonate and/or carbonate, the cathode electrolyte may be again contacted with the carbon from the source of carbon outside the cathode chamber to react any un-reacted hydroxide with the bicarbonate to produce the carbonate.

The conversion of carbonic acid and/or bicarbonate to the carbonate by sodium hydroxide may be dependent on the concentration of the sodium hydroxide produced by the cathode; the concentration of the carbon in the source of carbon reacted with the sodium hydroxide; and/or pH of the cathode electrolyte. The amount of carbonic acid and/or bicarbonate converted to the carbonate in the presence of sodium hydroxide, outside the cathode chamber and/or inside the cathode chamber, may be 100%; or more than 90%; or more than 80%; or more than 70%; or more than 60%; or more than 50%; or more than 40%; or more than 30%; or more than 20%; or more than 10%; or more than 5%; or more than 1%; or between 1-99%; or between 1-90%; or between 1-80%; or between 1-70%; or between 1-60%; or between 1-50%; or between 1-40%; or between 1-30%; or between 1-20%; or between 1-10%; or between 5-99%; or between 5-90%; or between 5-80%; or between 5-70%; or between 5-60%; or between 5-50%; or between 5-40%; or between 5-30%; or between 5-20%; or between 5-10%; or between 10-99%; or between 10-90%; or between 10-80%; or between 10-70%; or between 10-60%; or between 10-50%; or between 10-40%; or between 10-30%; or between 10-20%; or between 20-99%; or between 20-90%; or between 20-80%; or between 20-70%; or between 20-60%; or between 20-50%; or between 20-40%; or between 20-30%; or between 30-99%; or between 30-90%; or between 30-80%; or between 30-70%; or between 30-60%; or between 30-50%; or between 30-40%; or between 40-99%; or between 40-90%; or between 40-80%; or between 40-70%; or between 40-60%; or between 40-50%; or between 50-99%; or between 50-90%; or between 50-80%; or between 50-70%; or between 50-60%; or between 60-99%; or between 60-90%; or between 60-80%; or between 60-70%; or between 70-99%; or between 70-90%; or between 70-80%; or between 80-99%; or between 80-90%; or between 90-100%; or between 90-99%.

The system in some embodiments includes a cathode electrolyte circulating system adapted for withdrawing and circulating cathode electrolyte in the system. In one embodiment, the cathode electrolyte circulating system includes a carbon contactor outside the cathode chamber that is adapted for contacting the carbon from the source of carbon with the circulating cathode electrolyte, and for re-circulating the electrolyte in the system. As can be appreciated, since the pH of the cathode electrolyte can be adjusted by withdrawing and/or circulating cathode electrolyte/carbon from the source of carbon from the system, the pH of the cathode electrolyte compartment can be regulated by regulating an amount of cathode electrolyte removed from the system, passed through the carbon contactor, and/or re-circulated back into the cathode chamber.

In some embodiments, the systems provided herein include a contact system configured to contact the carbon from the source of carbon to the cathode electrolyte. The system or the contact system includes any means for directing the carbon from the source of carbon to the cathode electrolyte inside a cathode chamber. Such means for directing the carbon to the cathode electrolyte inside a cathode chamber are well known in the art and include, but not limited to, injection, pipe, duct, conduit, and the like. In some embodiments, the system or the contact system in the system includes a duct that directs the carbon to the cathode electrolyte inside a cathode chamber. It is to be understood that when the carbon from the source of carbon is contacted with the cathode electrolyte inside the cathode chamber, the carbon may be injected to the cathode electrolyte from the bottom of the cell, top of the cell, from the side inlet in the cell, and/or from all entry ports depending on the amount of carbon desired in the cathode chamber. It is to be understood that the amount of carbon from the source of carbon inside the cathode chamber may be dependent on the flow rate of the solution, desired pH of the cathode electrolyte, and/or size of the cell. Such optimization of the amount of the carbon from the source of carbon is well within the scope of the invention.

For the systems where the carbon from the source of carbon is contacted with the cathode electrolyte outside the cathode chamber, the sodium hydroxide containing cathode electrolyte may be withdrawn from the cathode chamber and may be added to a container configured to contain the carbon from the source of carbon. The container may have an input for the source of carbon such as a pipe or conduit, etc. or a pipeline in communication with the gaseous stream of CO₂, a solution containing dissolved form of CO₂, and/or the subterranean brine. The container may also be in fluid communication with a reactor where the source of carbon, such as, e.g. bicarbonate brine solution may be produced, modified, and/or stored.

In some embodiments, the source of carbon, such as, e.g. the bicarbonate brine solution may be a tanks or series of tanks containing the bicarbonate brine solution which is then connected to the input for the bicarbonate brine solution for contacting with the cathode electrolyte inside the cathode chamber and/or outside the cathode chamber. The methods and systems of the invention may also include producing one or more bore holes (i.e., well bore) in the subterranean formation to connect the subterranean brine to the system of the invention, such as, to connect to the input for the bicarbonate brine. One or more bore holes can be produced in the subterranean formation by employing any convenient protocol. For instance, bore holes may be produced using conventional excavation drilling techniques, e.g., particle jet drilling, rotary mechanical drilling, rotary blasthole drilling, hole openers, rock reamers, flycutters, turbine-motor drilling, thermal spallation drilling, high power pulse laser drilling or any combination thereof. The bore holes may be drilled to any depth as desired, depending upon the thickness of the walls and porosity of the subterranean formation. In some embodiments, the bore holes may extend to a depth of 1 meter or deeper into the subterranean formation, such as 5 meters or deeper into the subterranean formation, such as 10 meters or deeper into the subterranean formation, such as 20 meters or deeper into the subterranean formation, such as 30 meters or deeper into the subterranean formation, such as 40 meters or deeper into the subterranean formation, such as 50 meters or deeper into the subterranean formation, such as 75 meters or deeper into the subterranean formation, including 100 meters or 200 m or 300 m or 500 m deeper into the subterranean formation. The diameter of the bore hole may also vary, depending upon the nature and the porosity of the subterranean formation. In some embodiments, the diameter of the bore hole ranges, e.g., from 5 to 100 cm, such as 10 to 90 cm, such as 10 to 90 cm, such as 20 to 80 cm, such as 25 to 75 cm, and including 30 to 50 cm.

Bicarbonate brine disposed within the subterranean formation may be removed by any convenient protocol, such as, but not limited to, employing an oil-field pump, down-well turbine motor pump, rotary lobe pump, hydraulic pump, fluid transfer pump, geothermal well pump, a water-submersible vacuum pump, or surface-located brine pump, among other protocols. It is to be understood that the above recited methods and systems to collect a subterranean brine may be used for some embodiments of the invention where a subterranean carbonate brine, or an alkaline brine, or a hard brine, or an alkaline hard brine is desired. Brine disposed within the subterranean formation may be used in any methods of this invention, for example, as a source of alkalinity, source of carbonate brine, source of bicarbonate brine, source of cations, such as, divalent cations, and/or combinations thereof.

In some embodiments, the bicarbonate brine solution is contacted with the cathode electrolyte, with the flow rate of greater than 1 mL/min; or greater than 10 mL/min; or greater than 25 mL/min; or greater than 50 mL/min; or greater than 100 mL/min; or from 1 mL/min to 100 L/min; or from 1 mL/min to 75 L/min; or from 1 mL/min to 50 L/min; or from 1 mL/min to 40 L/min; or from 1 mL/min to 30 L/min; or from 1 mL/min to 20 L/min; or from 1 mL/min to 10 L/min; or from 1 mL/min to 5 L/min; or from 5 mL/min to 100 L/min; or from 5 mL/min to 50 L/min; or from 5 mL/min to 40 L/min; or from 5 mL/min to 30 L/min; or from 5 mL/min to 20 L/min; or from 5 mL/min to 10 L/min; or from 10 mL/min to 100 L/min; or from 10 mL/min to 50 L/min; or from 10 mL/min to 40 L/min; or from 10 mL/min to 30 L/min; or from 10 mL/min to 20 L/min; or from 10 mL/min to 15 L/min; or from 20 mL/min to 100 L/min; or from 20 mL/min to 50 L/min; or from 20 mL/min to 40 L/min; or from 20 mL/min to 30 L/min; or from 30 mL/min to 100 L/min; or from 30 mL/min to 50 L/min; or from 30 mL/min to 40 L/min; or from 30 mL/min to 35 L/min; or from 40 mL/min to 100 L/min; or from 40 mL/min to 50 L/min; or from 40 mL/min to 45 L/min; or from 50 mL/min to 100 L/min; or from 50 mL/min to 75 L/min. The concentration of the bicarbonate brine solution that is contacted with the cathode electrolyte inside and/or outside the cathode chamber is described below.

In some embodiments, the cathode and the anode may be operatively connected to an off-peak electrical voltage system that supplies off-peak voltage to the electrodes. Since the cost of off-peak power is lower than the cost of power supplied during peak power-supply times, the system can utilize off-peak power to produce an alkaline solution in the cathode electrolyte at a relatively lower cost.

As illustrated in FIG. 8, in some embodiments, the anode electrolyte including an acid, e.g., hydrochloric acid, and a depleted salt solution including low amount sodium ions, is operatively connected to a system for further processing of the acid, e.g., a mineral dissolution system 805 that is configured to dissolve minerals and produce a mineral solution including calcium ions and/or magnesium ions, e.g., mafic minerals such as olivine and serpentine. In some embodiments, not shown in FIG. 8, the acid may be used for other purposes in addition to or instead of mineral dissolution. Such uses include, but are not limited to, use as a reactant in production of cellulosic biofuels, use in the production of polyvinyl chloride (PVC), and the like. System appropriate to such uses may be operatively connected to the electrochemical unit, or the acid may be transported to the appropriate site for use.

In some embodiments, the mineral dissolution system 805 is operatively connected to nano-filtration system 807 that is configured to separate sodium ions and chloride ions from the mineral solution comprising, e.g., calcium ions, magnesium ions, silica, hydrochloric acid and/or sodium hydroxide. In some embodiments, the nano-filtration system 807 is configured with a reverse osmosis system 808 that is capable of or configured for concentrating sodium ions and chloride ions into a salt solution that is used as the anode electrolyte 203. Such nano-filters and the reverse osmosis systems are well known in the art.

In some embodiments, the system further includes a water treatment system configured for several uses, e.g., to dilute the brine, the hydrochloric acid, the cathode electrolyte, and/or anode electrolyte. Such water treatment systems are described in U.S. Patent Application Publication No. US 2010/0200419, filed 10 Feb. 2010, which is incorporated herein by reference in its entirety.

In some embodiments, hydroxide ions, carbonate ions and/or bicarbonate ions produced in the cathode electrolyte, and hydrochloric acid produced in the anode electrolyte are removed from the system, while sodium chloride in the salt solution electrolyte is replenished to maintain continuous operation of the system. As can be appreciated, in some embodiments, the system can be configured to operate in various production modes including batch mode, semi-batch mode, continuous flow mode, with or without the option to withdraw portions of the hydroxide solution produced in the cathode electrolyte, or withdraw all or a portion of the acid produced in the anode electrolyte, or direct the hydrogen gas produced at the cathode to the anode where it may be oxidized.

Depending on the flow rate of fluids into and out of the cathode electrolyte, the concentration of the sodium hydroxide solution, and the concentration of the gaseous stream of CO₂, or the concentration of the dissolved CO₂ in the solution, or the concentration of the bicarbonate brine solution in the cathode electrolyte, and the pH of the cathode electrolyte may adjust, e.g., the pH may increase, decrease or remain the same. In some embodiments, the pH of the cathode electrolyte decreases after contacting with the carbon from the source of carbon. Depending on the pH of the cathode electrolyte, the carbon from the source of carbon contacted with the cathode electrolyte reacts with the sodium hydroxide in the cathode electrolyte and reversibly dissociates and equilibrates to produce water and carbonate ions in the cathode electrolyte compartment as follows:

OH⁻+HCO₃⁻<==>H₂O+CO₃²⁻

The exiting solution from the cathode electrolyte may include sodium hydroxide, bicarbonate ions, and/or carbonate ions. The overall cell potential of the system can be determined through the Gibbs energy change of the reaction by the formula:

E_{cell}=−ΔG/nF

or, at standard temperature and pressure conditions:

E°_{cell}=−ΔG°/nF

where, E_{cell} is the cell voltage, ΔG is the Gibbs energy of reaction, n is the number of electrons transferred, and F is the Faraday constant (96485 J/Vmol). The E_{cell} of each of these reactions is pH dependent based on the Nernst equestion.

Also, the overall cell potential can be determined through the combination of Nernst equations for each half cell reaction:

E=E°−RT ln(Q)/nF

where, E° is the standard reduction potential, R is the universal gas constant, (8.314 J/mol K), T is the absolute temperature, n is the number of electrons involved in the half cell reaction, F is Faraday's constant (96485 JN mol), and Q is the reaction quotient such that:

Eₜₒₜₐₗ=E_{cathode}+E_{anode}

When hydrogen is oxidized to protons at the anode as follows:

H₂=2H⁺+2e,

E° is 0.00 V, n is 2, and Q is the square of the activity of H⁺ so that:

E_{anode}=+0.059 pHₐ,

where pHₐ is the pH of the anode electrolyte.

When water is reduced to hydroxide ions and hydrogen gas at the cathode as follows:

2H₂O+2e⁻=H₂+2OH⁻,

E° is −0.83 V, n is 2, and Q is the square of the activity of OH⁺ so that:

E_{cathode}=−0.059 pH_{c},

where pH_{c} is the pH of the cathode electrolyte.

The E for the cathode and the anode reactions varies with the pH of the anode and cathode electrolytes. Thus, if the anode reaction, which is occurring in an acidic environment, is at a pH of 0, then the E of the reaction is 0V for the half cell reaction. For the cathode reaction, if the generation of bicarbonate ions occur at a pH of 7, then the theoretical E is 7×(−0.059 V)=−0.413V for the half cell reaction where a negative E means energy is needed to be input into the half cell or full cell for the reaction to proceed. Thus, if the anode pH is 0 and the cathode pH is 7 then the overall cell potential would be −0.413V, where:

Eₜₒₜₐₗ=−0.059 (pHₐ−pH_{c})=−0.059 ΔpH

Thus, in some embodiments, directing carbon from the source of carbon into the cathode electrolyte may lower the pH of the cathode electrolyte by producing bicarbonate ions and/or carbonate ions in the cathode electrolyte, which consequently may lower the voltage across the anode and cathode.

Thus, if the cathode electrolyte is allowed to increase to a pH of 14 or greater, the difference between the anode half-cell potential and the cathode half-cell potential will increase to 0.83V. With increased duration of cell operation without carbon from the source of carbon addition or other intervention, e.g., diluting with water, the required cell potential will continue to increase. The cell potential may also increase due to ohmic resistance losses across the membranes in the electrolyte and the cell's overvoltage potential. Herein, an overvoltage potential includes the voltage difference between a thermodynamically determined half-cell reduction potential, and the experimentally observed potential at which the redox reaction occurs. The overvoltage potential is related to cell voltage efficiency as the overvoltage potential requires more energy than is thermodynamically required to drive a reaction. In each case, the extra energy is lost as heat. Overvoltage potential is specific to each cell design and will vary between cells and operational conditions even for the same reaction.

In one aspect, the methods provided herein include one or more of the following steps: contacting the anode with the anode electrolyte, contacting the cathode including the fine mesh cathode with the cathode electrolyte, contacting carbon from the source of carbon with the cathode electrolyte, and applying the voltage across the anode and the cathode. The carbon from the source of carbon is contacted with the cathode electrolyte inside the cathode chamber and/or outside the cathode chamber. The methods provided herein include producing an alkaline solution in the cathode electrolyte by applying a voltage with a voltage of less that 3V, or less than 2V, or less than 1V, or between 0.05-1V across the cathode including the fine mesh cathode and an anode without producing a gas at the anode. In some embodiments of the method, a first cation exchange membrane is partitioned between the anode electrolyte and the cathode electrolyte. In some embodiments of the method, the alkaline solution in the cathode electrolyte includes hydroxide ions and/or bicarbonate ions and/or carbonate ions. In some embodiments of the method, the method further includes producing the carbon from the source of carbon. In some embodiments of the method, the method further includes treating the bicarbonate ions and/or carbonate ions with the divalent cations to produce carbonate compositions.

In one aspect, the methods provided herein include one or more of the following steps: contacting an anode 204 with an anode electrolyte 203, contacting a cathode 201 including the fine mesh cathode with a cathode electrolyte 202, applying a voltage 209 across the anode and the fine mesh cathode; and contacting carbon from the source of carbon 205 with the cathode electrolyte 202. The carbon from the source of carbon is contacted with the cathode electrolyte inside the cathode chamber and/or outside the cathode chamber. The methods provided herein include producing an alkaline solution in the cathode electrolyte 202 by applying a voltage of less that 3V, or less than 2V, or less than 1V, or between 0.05-1V across the cathode and an anode without producing a gas at the anode. In some embodiments of the method, a first cation exchange membrane 206 is partitioned between the anode electrolyte 203 and the cathode electrolyte 202. In some embodiments of the method, the anode 204 is in contact with a second cation exchange membrane 212 that separates the anode 204 from the anode electrolyte 203. In some embodiments of the method, the alkaline solution in the cathode electrolyte 202 includes hydroxide ions and/or bicarbonate ions and/or carbonate ions. In some embodiments, the method provided herein include one or more steps: the ambient air is excluded in the cathode electrolyte 202; a pH of between and 7 and 14 or greater is maintained in the cathode electrolyte 202; a pH of from less than 0 and up to 7 is maintained in the anode electrolyte 203; hydrogen gas is oxidized at the anode 204 to produce hydrogen ions and hydrogen ions are migrated from the anode 204 through the second cation exchange membrane 212 into the anode electrolyte 203; hydroxide ions and hydrogen gas are produced at the cathode 201 including the fine mesh cathode; hydroxide ions are migrated from the cathode 201 into the cathode electrolyte 202; hydrogen gas is directed from the cathode 201 to the anode 204; cations are migrated from the anode electrolyte 203 through the first cation exchange membrane 206 into the cathode electrolyte 202 wherein the cations comprise sodium ions. In some embodiments, the anions are migrated from the cathode electrolyte 202 through the anion exchange membrane 213 into the anode electrolyte 203 wherein the anions include chloride ions. In some embodiments, the anions are migrated from the sodium chloride solution through the anion exchange membrane 213 into the anode electrolyte 203 and cations are migrated from the sodium chloride through the first cation exchange membrane 206 into the cathode electrolyte 202.

In some embodiments, the methods provided herein include one or more of the following steps: applying voltage 209 across a cathode 201 including the fine mesh cathode and a gas diffusion anode 204 in an electrochemical system, wherein the cathode contacts a cathode electrolyte 202. In some embodiments, the method includes providing hydrogen to the gas diffusion anode 204; contacting the cathode 201 including the fine mesh cathode with a cathode electrolyte 202; and applying a voltage 209 across the anode and cathode; directing hydrogen gas from the cathode 201 to the anode 204; interposing an anion exchange membrane 213 between the anode electrolyte 203 and the salt solution 211; interposing a first cation exchange membrane 206 between the cathode electrolyte 202 and the salt solution 211, where the salt solution is contained between the anion exchange membrane 213 and the first cation exchange membrane 206; where anions migrate from the salt solution to the anode electrolyte through the anion exchange membrane, and cations migrate from the salt solution to the cathode electrolyte through the first cation exchange membrane; producing hydroxide ions and/or carbonate ions and/or bicarbonate ions in the cathode electrolyte; producing an acid in the anode electrolyte; producing sodium hydroxide and/or sodium carbonate and/or sodium bicarbonate in the cathode electrolyte; whereby protons are migrated from the anode to the anode electrolyte; whereby hydrochloric acid is produced in the anode electrolyte; producing partially desalinated water from the salt solution; withdrawing a first portion of the cathode electrolyte and contacting the portion of cathode electrolyte with source of carbon; and contacting the portion of cathode electrolyte and the carbon from the source of carbon with a divalent cation solution; whereby protons are produced at the anode and hydroxide ions and hydrogen gas produced at the cathode; whereby a gas is not produced at the anode when the voltage is applied across the anode and cathode; where the voltage applied across the anode and cathode is less than 2V.

In some embodiments, hydroxide ions are formed at the cathode and in the cathode electrolyte by applying a voltage of less than 2V across the anode and cathode without forming a gas at the anode, while providing hydrogen gas at the anode for oxidation at the anode. In some embodiments, the methods do not form a gas at the anode when the voltage applied across the anode and cathode including the fine mesh cathode is less than 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1 V or less, or between 0.1V-3V, or between 0.1V-2.5V, or between 0.1V-2V, or between 0.1V-1.5V, or between 0.1V-1V, or between 0.1V-0.5V, or between 0.05-1, or between 0.05-2V, while hydrogen gas is provided to the anode where it is oxidized to protons. As will be appreciated by one ordinarily skilled in the art, by not forming a gas at the anode and by providing hydrogen gas to the anode for oxidation at the anode; by adding carbon from the source of carbon to the cathode electrolyte inside the cathode chamber; by controlling the resistance in the system, for example, by decreasing the electrolyte path lengths; and by selecting ionic membranes with low resistance and any other method know in the art, hydroxide ions can be produced in the cathode electrolyte with the lower voltages, as described herein.

In some embodiments, the method includes producing sodium hydroxide and/or sodium carbonate ions and/or sodium bicarbonate ions in the cathode electrolyte; producing an acid and a depleted salt solution in the anode electrolyte including sodium ions and chloride ions; utilizing the anode electrolyte to dissolve minerals and produce a mineral solution comprising calcium ions and/or magnesium ions, wherein the minerals comprises mafic minerals; filtering the mineral solution to produce a filtrate comprising sodium ions and chloride ions; concentrating the filtrate to produce the salt solution, wherein the concentrator comprises a reverse osmosis system; utilizing the salt solution as the anode electrolyte; precipitating a carbonate and/or bicarbonate with the cathode electrolyte; wherein the carbonate and/or bicarbonate comprises calcium and/or magnesium carbonate and/or bicarbonate. In some embodiments, the method includes disposing of the acid in an underground storage site where the acid can be stored in an un-reactive salt or rock formation and hence does not cause an environmental acidification.

With reference to figures, the method in some embodiments includes producing an acid in an electrochemical system and contacting a mineral 806 with the acid. In some embodiments, the method further produces the acid in the anode electrolyte 203, without generating a gas at the anode 204, and oxidizing hydrogen gas 207 at the anode, wherein the acid comprises hydrochloric acid 210; and wherein the hydrogen gas 207 is produced at the cathode 201; producing an alkaline solution in the cathode electrolyte 202; migrating sodium ions into the cathode electrolyte; wherein the alkaline solution comprises sodium hydroxide, sodium bicarbonate and/or sodium carbonate; wherein the voltage is less than 2V or less than 1V; wherein the anode electrolyte 203 is separated from the cathode electrolyte 202 by first cation exchange membrane 206; wherein the anode 204 includes a second cation exchange membrane 212 in contact with the anode electrolyte 203; wherein the anode electrolyte comprises a salt, e.g., sodium chloride; dissolving a mineral 806 with the acid 210 to produce a mineral solution; producing calcium ions and/or magnesium ions; wherein the mineral comprises a mafic mineral, e.g. olivine or serpentine; filtering the mineral solution to produce a filtrate comprising sodium ions and chloride ions solution; concentrating the filtrate to produce a salt solution; utilizing the salt solution as the anode electrolyte 203; precipitating a carbonate and/or bicarbonate with the cathode electrolyte 202 by contacting the divalent cations with the cathode electrolyte; wherein the carbonate and/or bicarbonate includes calcium and/or magnesium carbonate and/or bicarbonate. In some embodiments, the method includes disposing of the acid in an underground storage site where the acid can be stored in an un-reactive salt or rock formation and hence does not cause an environmental acidification.

In some embodiments, the anode electrolyte and the cathode electrolyte in the electrochemical cell, in the methods and systems provided herein, are operated at room temperature or at elevated temperatures, such as, e.g., at more than 40° C., or more than 50° C., or more than 60° C., or more than 70° C., or more than 80° C., or between 30-70° C.

In some embodiments, depending on the ionic species desired in the cathode electrolyte 202 and/or the anode electrolyte 203 and/or the salt solution 211, alternative reactants can be utilized. Thus, for example, if a potassium salt such as potassium hydroxide or potassium carbonate is desired in the cathode electrolyte 202, then a potassium salt such as potassium chloride can be utilized in the salt solution 211. Similarly, if sulfuric acid is desired in the anode electrolyte, then a sulfate such as sodium sulfate, potassium sulfate, magnesium sulfate, or the like, can be utilized in the salt solution 211.

### Methods and Systems to Produce Carbonate Compositions

As described above, the carbon from the source of carbon after being contacted with the sodium hydroxide in the cathode electrolyte, results in carbonate formation. The methods and systems provided herein are further configured to process the sodium carbonate/sodium bicarbonate solution obtained after the cathode electrolyte is contacted with the carbon from the source of carbon.

With reference to FIGS. 2A, 2B, 3A, 3B, 4A, 4B, 5A, 5B, 6A, and 6B, in some embodiments, the system is configured for further processing of the cathode electrolyte 202 after the cathode electrolyte is contacted with the carbon from the source of carbon 205 outside and/or inside the cathode chamber. As illustrated in FIG. 8, the system is configured with a precipitator 803 to precipitate carbonates and/or bicarbonates from the solution using divalent cations, e.g., calcium, magnesium, or combination thereof. In some embodiments, the solution, obtained after the contacting of the cathode electrolyte with the carbon from the source of carbon, is subjected to the precipitation conditions in the precipitator. The solution obtained after the contacting of the cathode electrolyte with the carbon from the source of carbon includes sodium hydroxide and/or sodium carbonate, and/or sodium bicarbonate.

The divalent cations include any solid or solution that contains divalent cations, such as, alkaline earth metal ions or any aqueous medium containing alkaline earth metals. The alkaline earth metals include calcium, magnesium, strontium, barium, etc. or combinations thereof. The divalent cations (e.g., alkaline earth metal cations such as Ca²⁺ and Mg²⁺) may be found in industrial wastes, seawater, brines, hard water, minerals, and many other suitable sources. The alkaline-earth-metal-containing water includes fresh water or saltwater, depending on the method employing the water. In some embodiments, the water employed in the process includes one or more alkaline earth metals, e.g., magnesium, calcium, etc. In some embodiments, the alkaline earth metal ions are present in an amount of 1% to 99% by wt; or 1% to 95% by wt; or 1% to 90% by wt; or 1% to 80% by wt; or 1% to 70% by wt; or 1% to 60% by wt; or 1% to 50% by wt; or 1% to 40% by wt; or 1% to 30% by wt; or 1% to 20% by wt; or 1% to 10% by wt; or 20% to 95% by wt; or 20% to 80% by wt; or 20% to 50% by wt; or 50% to 95% by wt; or 50% to 80% by wt; or 50% to 75% by wt; or 75% to 90% by wt; or 75% to 80% by wt; or 80% to 90% by wt of the solution containing the alkaline earth metal ions. In some embodiments, the alkaline earth metal ions are present in saltwater, such as, seawater. In some embodiments, the source of divalent cations is hard water or naturally occurring hard brines. In some embodiments, calcium rich waters may be combined with magnesium silicate minerals, such as olivine or serpentine.

In some locations, industrial waste streams from various industrial processes provide for convenient sources of cations (as well as in some cases other materials useful in the process, e.g., metal hydroxide). Such waste streams include, but are not limited to, mining wastes; fossil fuel burning ash (e.g., fly ash, bottom ash, boiler slag); slag (e.g., iron slag, phosphorous slag); cement kiln waste (e.g., cement kiln dust); oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. In some embodiments, the aqueous solution of cations comprises calcium and/or magnesium in amounts ranging from 10-50,000 ppm; or 10-10,000 ppm; or 10-5,000 ppm; or 10-1,000 ppm; or 10-100 ppm; or 50-50,000 ppm; or 50-10,000 ppm; or 50-1,000 ppm; or 50-100 ppm; or 100-50,000 ppm; or 100-10,000 ppm; or 100-1,000 ppm; or 100-500 ppm; or 1,000-50,000 ppm; or 1,000-10,000 ppm; or 5,000-50,000 ppm; or 5,000-10,000 ppm; or 10,000-50,000 ppm.

Freshwater may be a convenient source of cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of cations such as alkaline earth metal cations (e.g., Ca²⁺, Mg²⁺, etc.) to produce a mineral-rich water that is suitable for methods and systems described herein. Cations or precursors thereof (e.g., salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, freshwater comprising Ca²⁺ is combined with magnesium silicates (e.g., olivine or serpentine), or products or processed forms thereof, yielding a solution comprising calcium and magnesium cations.

In some embodiments, as illustrated in FIGS. 2A, 3A, 4A, 5A, and 6A, where the carbon from the source of carbon is contacted with the cathode electrolyte inside the cathode chamber, the system is configured to treat bicarbonate and/or carbonate ions in the cathode electrolyte with a divalent cation selected from the group consisting of calcium, magnesium, and combination thereof. In some embodiments, bicarbonate and/or carbonate ions in the cathode electrolyte can be treated with the divalent cations inside the cathode chamber where a solution containing the divalent cations is added to the cathode electrolyte after the addition of the carbon from the source of carbon to the cathode chamber. In some embodiments, bicarbonate and/or carbonate ions in the cathode electrolyte react with the divalent cations inside the cathode chamber when the cathode electrolyte already includes divalent cations, such as seawater. In some embodiments, bicarbonate and/or carbonate ions in the cathode electrolyte can be treated with the divalent cations outside the cathode chamber, e.g. in a precipitator, where the cathode electrolyte containing the hydroxide, bicarbonate and/or carbonate is withdrawn from the cathode chamber and is treated with the divalent cations outside the cathode chamber.

In some embodiments, as illustrated in FIGS. 2B, 3B, 4B, 5B, 6B, where the carbon from the source of carbon is contacted with the cathode electrolyte outside the cathode chamber, the system is configured to treat bicarbonate and/or carbonate ions in the solution with a divalent cation selected from the group consisting of calcium, magnesium, and combination thereof. In embodiments where the solution is obtained after the contacting of the cathode electrolyte with the carbon from the source of carbon outside the cathode chamber, the solution is mixed with the divalent cations in a precipitator. In some embodiments, the cathode electrolyte, the carbon from the source of carbon, and the divalent cations are all mixed in the precipitator outside the cathode chamber to precipitate the carbonate materials.

The precipitator can be a tank or a series of tanks Contact protocols include, but are not limited to, direct contacting protocols, e.g., flowing the bicarbonate brine solution through the volume of water containing cations, e.g. alkaline earth metal ions and through the volume of cathode electrolyte containing sodium hydroxide; concurrent contacting means, e.g., contact between unidirectionally flowing liquid phase streams; and countercurrent means, e.g., contact between oppositely flowing liquid phase streams, and the like. Thus, contact may be accomplished through use of infusers, bubblers, fluidic Venturi reactor, sparger, gas filter, spray, tray, or packed column reactors, and the like, as may be convenient. In some embodiments, the contact is by spray. In some embodiments, the contact is through packed column. In some embodiments, the carbon from the source of carbon is added to the source of cations and the cathode electrolyte containing sodium hydroxide. In some embodiments, the source of cations and the cathode electrolyte containing sodium hydroxide is added to the carbon from the source of carbon. In some embodiments, both the source of cations and the carbon from the source of carbon are simultaneously added to the cathode electrolyte containing sodium hydroxide in the precipitator for precipitation.

In some embodiments, where the carbon from the source of carbon has been added to the cathode electrolyte inside the cathode chamber, the withdrawn cathode electrolyte including sodium hydroxide, sodium bicarbonate and/or sodium carbonate is administered to the precipitator for further reaction with the divalent cations. In some embodiments, where the carbon from the source of carbon and the divalent cations have been added to the cathode electrolyte inside the cathode chamber, the withdrawn cathode electrolyte including sodium hydroxide, calcium carbonate, magnesium carbonate, calcium bicarbonate, magnesium bicarbonate, calcium magnesium carbonate, or combination thereof, is administered to the precipitator for further processing.

The precipitate obtained after the contacting of the carbon from the source of carbon with the cathode electrolyte and the divalent cations includes calcium carbonate, magnesium carbonate, calcium bicarbonate, magnesium bicarbonate, calcium magnesium carbonate, or combination thereof. In some embodiments, the precipitate may be subjected to one or more of steps including, but not limited to, dewatering, washing of the precipitate, dewatering of the washed precipitate, drying, milling, storing, to make the carbonate composition of the invention.

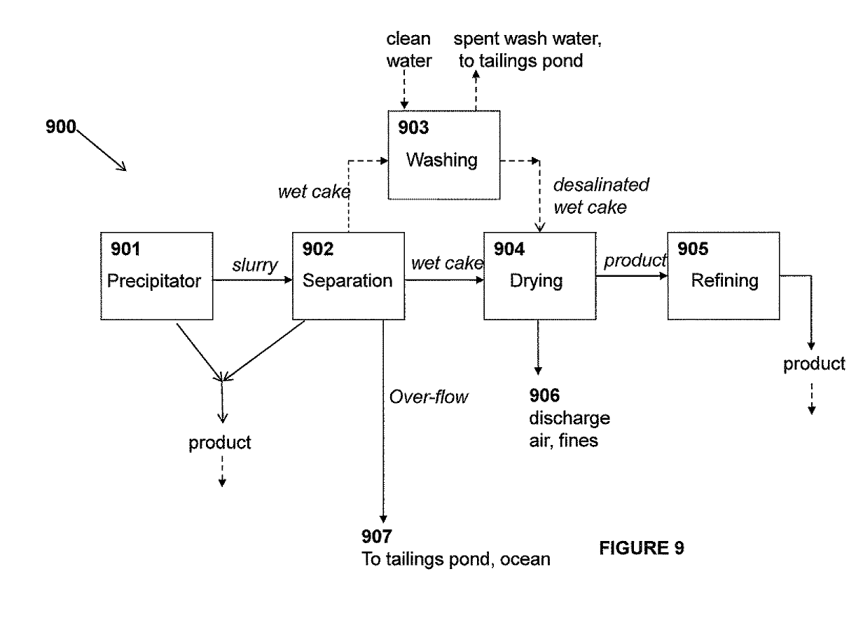

In some embodiments, the processing of the precipitate is as illustrated in FIG. 9. The precipitator 901 containing the solution of calcium carbonate, magnesium carbonate, calcium bicarbonate, magnesium bicarbonate, calcium magnesium carbonate, or combination thereof is subjected to precipitation conditions. At precipitation step, carbonate compounds, which may be amorphous or crystalline, are precipitated. These carbonate compounds may form a reaction product comprising carbonic acid, bicarbonate, carbonate, or mixture thereof. The carbonate precipitate may be the self-cementing composition and may be stored as is in the mother liquor or may be further processed to make the cement products. Alternatively, the precipitate may be subjected to further processing to give the hydraulic cement or the supplementary cementitious materials (SCM) compositions. The self-cementing compositions, hydraulic cements, and SCM have been described in U.S. application Ser. No. 12/857,248, filed 16 Aug. 2010, which is incorporated herein by reference in its entirety.

The one or more conditions or one or more precipitation conditions of interest include those that change the physical environment of the water to produce the desired precipitate product. Such one or more conditions or precipitation conditions include, but are not limited to, one or more of temperature, pH, precipitation, dewatering or separation of the precipitate, drying, milling, and storage. For example, the temperature of the water may be within a suitable range for the precipitation of the desired composition to occur. For example, the temperature of the water may be raised to an amount suitable for precipitation of the desired carbonate compound(s) to occur. In such embodiments, the temperature of the water may be from 5 to 70° C., such as from 20 to 50° C., and including from 25 to 45° C. As such, while a given set of precipitation conditions may have a temperature ranging from 0 to 100° C., the temperature may be raised in certain embodiments to produce the desired precipitate. In certain embodiments, the temperature is raised using energy generated from low or zero carbon dioxide emission sources, e.g., solar energy source, wind energy source, hydroelectric energy source, etc.

The residence time of the precipitate in the precipitator 901 before the precipitate is removed from the solution, may vary. In some embodiments, the residence time of the precipitate in the solution is more than 5 seconds, or between 5 seconds-1 hour, or between 5 seconds-1 minute, or between 5 seconds to 20 seconds, or between 5 seconds to 30 seconds, or between 5 seconds to 40 seconds. Without being limited by any theory, it is contemplated that the residence time of the precipitate may affect the size of the particle. For example, a shorter residence time may give smaller size particles or more disperse particles whereas longer residence time may give agglomerated or larger size particles. In some embodiments, the residence time in the process of the invention may be used to make small size as well as large size particles in a single or multiple batches which may be separated or may remain mixed for later steps of the process.

The nature of the precipitate may also be influenced by selection of appropriate major ion ratios. Major ion ratios may have influence on polymorph formation, such that the carbonate products are metastable forms, such as, but not limited to vaterite, aragonite, amorphous calcium carbonate, or combination thereof. In some embodiments, the carbonate products may also include calcite. Such polymorphic precipitates are described in U.S. application Ser. No. 12/857,248, filed 16 Aug. 2010, which is incorporated herein by reference in its entirety. For example, magnesium may stabilize the vaterite and/or amorphous calcium carbonate in the precipitate. Rate of precipitation may also influence compound polymorphic phase formation and may be controlled in a manner sufficient to produce a desired precipitate product. The most rapid precipitation can be achieved by seeding the solution with a desired polymorphic phase. Without seeding, rapid precipitation can be achieved by rapidly increasing the pH of the sea water. The higher the pH is, the more rapid the precipitation may be.

In some embodiments, a set of conditions to produce the desired precipitate from the water include, but are not limited to, the water's temperature and pH, and in some instances the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate compound precipitates according to the invention may be batch or continuous protocols. It will be appreciated that precipitation conditions may be different to produce a given precipitate in a continuous flow system compared to a batch system.

Following production of the carbonate precipitate from the water, the resultant precipitated carbonate composition may be separated from the mother liquor or dewatered to produce the precipitate product, as illustrated at step 902 of FIG. 9. Alternatively, the precipitate is left as is in the mother liquor or mother supernate and is used as a cementing composition. Separation of the precipitate can be achieved using any convenient approach, including a mechanical approach, e.g., where bulk excess water is drained from the precipitated, e.g., either by gravity alone or with the addition of vacuum, mechanical pressing, by filtering the precipitate from the mother liquor to produce a filtrate, etc. Separation of bulk water produces a wet, dewatered precipitate. The dewatering station may be any number of dewatering stations connected to each other to dewater the slurry (e.g., parallel, in series, or combination thereof).

The above protocol results in the production of slurry of the precipitate and mother liquor. This precipitate in the mother liquor and/or in the slurry may give the self-cementing composition. In some embodiments, a portion or whole of the dewatered precipitate or the slurry is further processed to make the hydraulic cement or the SCM compositions.

Where desired, the compositions made up of the precipitate and the mother liquor may be stored for a period of time following precipitation and prior to further processing. For example, the composition may be stored for a period of time ranging from 1 to 1000 days or longer, such as 1 to 10 days or longer, at a temperature ranging from 1 to 40° C., such as 20 to 25° C.

The slurry components are then separated. Embodiments may include treatment of the mother liquor, where the mother liquor may or may not be present in the same composition as the product. The resultant mother liquor of the reaction may be disposed of using any convenient protocol. In certain embodiments, it may be sent to a tailings pond 907 for disposal. In certain embodiments, it may be disposed of in a naturally occurring body of water, e.g., ocean, sea, lake or river. In certain embodiments, the mother liquor is returned to the source of feedwater for the methods of invention, e.g., an ocean or sea. Alternatively, the mother liquor may be further processed, e.g., subjected to desalination protocols, as described further in U.S. application Ser. No. 12/163,205, filed Jun. 27, 2008; the disclosure of which is herein incorporated by reference.

The resultant dewatered precipitate is then dried to produce the carbonate composition of the invention, as illustrated at step 904 of FIG. 9. Drying can be achieved by air drying the precipitate. Where the precipitate is air dried, air drying may be at a temperature ranging from −70 to 120° C., as desired. In certain embodiments, drying is achieved by freeze-drying (i.e., lyophilization), where the precipitate is frozen, the surrounding pressure is reduced and enough heat is added to allow the frozen water in the material to sublime directly from the frozen precipitate phase to gas. In yet another embodiment, the precipitate is spray dried to dry the precipitate, where the liquid containing the precipitate is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc. The drying step may discharge air and fines 906.

In some embodiments, the step of spray drying may include separation of different sized particles of the precipitate. Where desired, the dewatered precipitate product from 902 may be washed before drying, as illustrated at step 903 of FIG. 9. The precipitate may be washed with freshwater, e.g., to remove salts (such as NaCl) from the dewatered precipitate. Used wash water may be disposed of as convenient, e.g., by disposing of it in a tailings pond, etc. The water used for washing may contain metals, such as, iron, nickel, etc.

As illustrated in FIG. 9, at step 905, the dried precipitate is refined, milled, aged, and/or cured, e.g., to provide for desired physical characteristics, such as particle size, surface area, zeta potential, etc., or to add one or more components to the precipitate, such as admixtures, aggregate, supplementary cementitious materials, etc., to produce the carbonate composition. Refinement may include a variety of different protocols. In certain embodiments, the product is subjected to mechanical refinement, e.g., grinding, in order to obtain a product with desired physical properties, e.g., particle size, etc. The dried precipitate may be milled or ground to obtain a desired particle size.

The cementitous composition, thus formed, has elements or markers that originate from the carbon from the source of carbon used in the process. The composition after setting, and hardening has a compressive strength of at least 14 MPa; or at least 16 MPa; or at least 18 MPa; or at least 20 MPa; or at least 25 MPa; or at least 30 MPa; or at least 35 MPa; or at least 40 MPa; or at least 45 MPa; or at least 50 MPa; or at least 55 MPa; or at least 60 MPa; or at least 65 MPa; or at least 70 MPa; or at least 75 MPa; or at least 80 MPa; or at least 85 MPa; or at least 90 MPa; or at least 95 MPa; or at least 100 MPa; or from 14-100 MPa; or from 14-80 MPa; or from 14-75 MPa; or from 14-70 MPa; or from 14-65 MPa; or from 14-60 MPa; or from 14-55 MPa; or from 14-50 MPa; or from 14-45 MPa; or from 14-40 MPa; or from 14-35 MPa; or from 14-30 MPa; or from 14-25 MPa; or from 14-20 MPa; or from 14-18 MPa; or from 14-16 MPa; or from 17-35 MPa; or from 17-30 MPa; or from 17-25 MPa; or from 17-20 MPa; or from 17-18 MPa; or from 20-100 MPa; or from 20-90 MPa; or from 20-80 MPa; or from 20-75 MPa; or from 20-70 MPa; or from 20-65 MPa; or from 20-60 MPa; or from 20-55 MPa; or from 20-50 MPa; or from 20-45 MPa; or from 20-40 MPa; or from 20-35 MPa; or from 20-30 MPa; or from 20-25 MPa; or from 30-100 MPa; or from 30-90 MPa; or from 30-80 MPa; or from 30-75 MPa; or from 30-70 MPa; or from 30-65 MPa; or from 30-60 MPa; or from 30-55 MPa; or from 30-50 MPa; or from 30-45 MPa; or from 30-40 MPa; or from 30-35 MPa; or from 40-100 MPa; or from 40-90 MPa; or from 40-80 MPa; or from 40-75 MPa; or from 40-70 MPa; or from 40-65 MPa; or from 40-60 MPa; or from 40-55 MPa; or from 40-50 MPa; or from 40-45 MPa; or from 50-100 MPa; or from 50-90 MPa; or from 50-80 MPa; or from 50-75 MPa; or from 50-70 MPa; or from 50-65 MPa; or from 50-60 MPa; or from 50-55 MPa; or from 60-100 MPa; or from 60-90 MPa; or from 60-80 MPa; or from 60-75 MPa; or from 60-70 MPa; or from 60-65 MPa; or from 70-100 MPa; or from 70-90 MPa; or from 70-80 MPa; or from 70-75 MPa; or from 80-100 MPa; or from 80-90 MPa; or from 80-85 MPa; or from 90-100 MPa; or from 90-95 MPa; or 14 MPa; or 16 MPa; or 18 MPa; or 20 MPa; or 25 MPa; or 30 MPa; or 35 MPa; or 40 MPa; or 45 MPa. For example, in some embodiments of the foregoing aspects and the foregoing embodiments, the composition after setting, and hardening has a compressive strength of 14 MPa to 40 MPa; or 17 MPa to 40 MPa; or 20 MPa to 40 MPa; or 30 MPa to 40 MPa; or 35 MPa to 40 MPa. In some embodiments, the compressive strengths described herein are the compressive strengths after 1 day, or 3 days, or 7 days, or 28 days.

The precipitates, comprising, e.g., calcium and magnesium carbonates and bicarbonates in some embodiments may be utilized as building materials, e.g., as cements and aggregates, as described in commonly assigned U.S. patent application Ser. No. 12/126,776, filed on 23 May 2008, herein incorporated by reference in its entirety.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXAMPLES

### Example 1

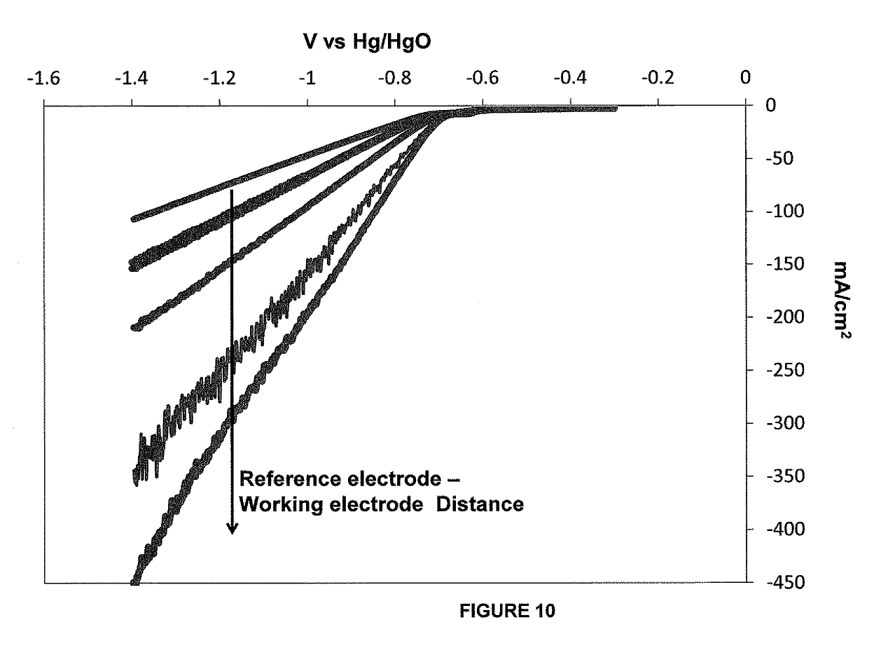

In this study, an effect of the solution resistance was observed on the voltage of the cathode electrode. In a beaker, a three-electrode system was set up. Working electrode was a proprietary cathode mesh, reference electrode was Hg/HgO, and the counter electrode was a platinum guaze electrode. The electrolyte used in this reaction was 1M sodium bicarbonate. A voltage was applied to the cell and the distance between the reference electrode and the working electrode was progressively decreased during the experiment. The solution resistance would be progressively lower as the distance between the reference electrode and the working electrode is decreased. The voltage of the cell was measured at each variation of the distance between the reference electrode and the working electrode. FIG. 10 illustrates that as the distance between the reference electrode and the working electrode was progressively decreased, the solution resistance also progressively decreased, thereby reducing the voltage.

This solution resistance effect is analogous to the effect of the replacement of the coarse mesh cathode with the fine mesh cathode where the solution resistance is low in the fine mesh cathode as the pore size is smaller, thereby reducing the voltage. This experiment demonstrates that there would be substantial voltage savings when the coarse mesh cathode is replaced or supplemented with a fine mesh cathode.

### Example 2

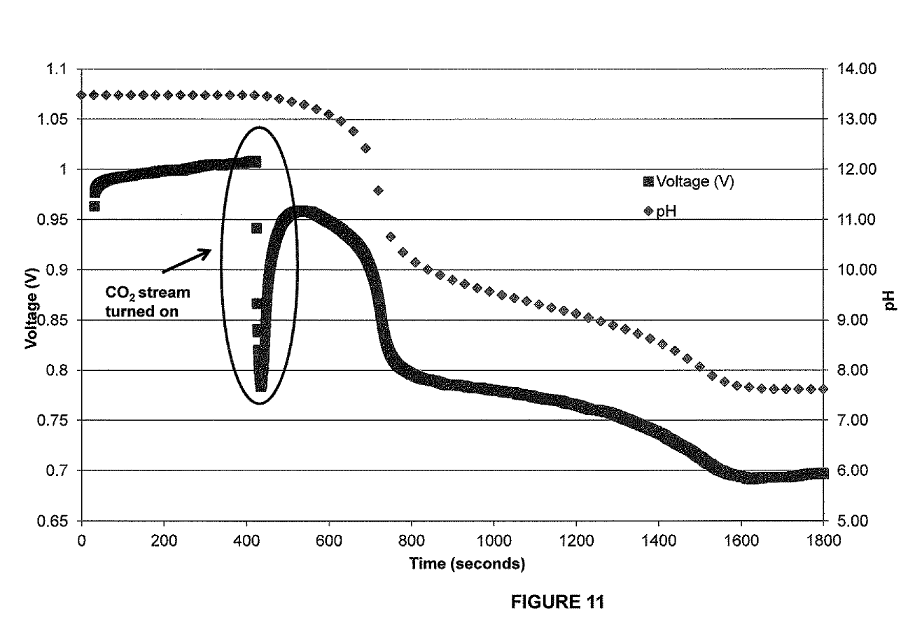

In this study, an effect of dissolving of CO₂ in the cathode electrolyte on the voltage of the cell was observed. In an electrochemical system, a platinum loaded gas diffusion electrode was utilized as the anode and a nickel mesh was utilized as the cathode. Original cell concentrations were 5M NaCl, 1M NaOH and 1M HCl in the electrolyte between the anion exchange membrane and the cation exchange membrane, the cathode electrolyte and anode electrolyte, respectively. The ionic membranes were obtained from Membrane International, Inc., of NJ, USA, in particular membrane no. AMI 7001 for anion exchange membrane and membrane no. CMI 7000 for cation exchange membrane. The electrochemical system was configured and operated with constant current density while carbon dioxide gas was continuously dissolved into the cathode electrolyte in the cathode compartment. In the system, the pH in the cathode electrolyte and the voltage across the anode and cathode were monitored. As illustrated in FIG. 11, as the reaction proceeded, the pH of the cathode electrolyte decreased (from pH of about 14 initially to pH of between 7-8 after dissolving carbon dioxide) as carbon dioxide gas was absorbed in the cathode electrolyte and the voltage across the anode and cathode also decreased (less than 2 V or less than 0.8 V).

The solubility of carbon dioxide in the cathode electrolyte is dependent on the pH of the electrolyte, and the voltage across the cathode and anode is dependent on the pH difference between the anode electrolyte and cathode electrolyte. Thus, as is illustrated in FIG. 11, the system was configured and operated at a pH less than 12, or a pH differential between the anode and the cathode between 6-12 (with anode pH being 0) and voltage of less than 2V or less than 0.8V by absorbing carbon dioxide to produce carbonic acid, carbonate ions and/or bicarbonate ions in the cathode electrolyte. The sodium hydroxide formed in the cathode electrolyte converted bicarbonate ions to carbonate ions forming about 1M sodium carbonate.

What is claimed is:

1. A method, comprising:
contacting an anode with an anode electrolyte;
contacting a cathode with a cathode electrolyte wherein said cathode comprises a fine mesh cathode;
applying voltage across said anode and said cathode;
producing hydroxide ions at said cathode; and
treating said hydroxide ions with carbon from a source of carbon.

2. The method of claim 1, wherein said cathode further comprises a coarse mesh cathode.

3. The method of claim 2, wherein said fine mesh cathode and/or coarse mesh cathode comprises metal, metal oxide, or combination thereof.

4. The method of claim 1, wherein said fine mesh cathode is a woven mesh or an expanded mesh.

5. The method of claim 1, wherein said fine mesh cathode is coated with a platinum group metal.

6. The method of claim 1, wherein said fine mesh cathode has a pore size between 0.01 mm to 3 mm.

7. The method of claim 1, wherein said fine mesh cathode is made of wire of thickness between 0.01 mm to 2.5 mm.

8. The method of claim 1, wherein said fine mesh cathode reduces voltage applied across said anode and said cathode as compared to said voltage with a coarse mesh cathode.

9. The method of claim 9, wherein said fine mesh cathode reduces said voltage by between 100 mV to 1000 mV.

10. The method of claim 1, wherein said anode does not form a gas.

11. The method of claim 1, wherein hydrogen gas is produced at said cathode and said hydrogen gas is directed from said cathode to said anode.

12. The method of claim 1, wherein said cathode electrolyte and said anode electrolyte are separated by an ion exchange membrane.

13. The method of claim 12, wherein said ion exchange membrane is an anion exchange membrane, a cation exchange membrane, or both.

14. The method of claim 1, wherein said hydroxide ions capture said carbon from said source of carbon to produce bicarbonate and/or carbonate ions.

15. The method of claim 14, further comprising treating bicarbonate and/or carbonate ions with a divalent cation selected from the group consisting of calcium, magnesium, and combination thereof.

16. The method of claim 1, wherein said source of carbon is gaseous stream of CO₂, a solution comprising dissolved CO₂, bicarbonate brine solution, or combination thereof.

17. The method of claim 1, wherein pH of said cathode electrolyte is between about 7-12.

18. An electrochemical cell system, comprising:
an anode in contact with an anode electrolyte;
a cathode in contact with a cathode electrolyte wherein said cathode is a fine mesh cathode; and
a contact system configured to contact said cathode electrolyte with carbon from a source of carbon.

19. The electrochemical cell system of claim 18, wherein said system further includes a device adapted to provide voltage across said anode and said cathode.

20. The electrochemical cell system of claim 18, wherein said system further includes a hydrogen gas delivery system to deliver hydrogen gas to said anode.
